(19) United States
(12) Patent Application Publication
(10) Pub. No.: US 2025/0188289 A1
(43) Pub. Date: Jun. 12, 2025

(54) FIRE-RETARDANT COMPOSITIONS AND OTHER COMPOSITIONS CONTAINING ONE OR MORE BIOPOLYMERS AND COLLOIDAL SILICA

(71) Applicant: PERIMETER SOLUTIONS LP, Clayton, MO (US)

(72) Inventors: Melissa KIM, Ontario, CA (US); Marcela MUNOZ, Fontana, CA (US); Daniel MORAGA, Rancho Cucamonga, CA (US)

(21) Appl. No.: 18/836,425

(22) PCT Filed: Apr. 4, 2022
(86) PCT No.: PCT/US2022/023339

§ 371 Date: Aug. 7, 2024

Related U.S. Application Data
(60) Provisional application No. 63/171,322, filed on Apr. 6, 2021.
(60) Provisional application No. 63/171,327, filed on Apr. 6, 2021.

(51) Int. Cl. C09D 5/18; C09D 5/08; C09D 7/40; C09D 7/43; C09D 7/62; C09D 7/63; C09D 7/65; C09D 105/00

(52) U.S. Cl. CPC C09D 5/18; C09D 5/084; C09D 5/086; C09D 7/43; C09D 7/62; C09D 7/63; C09D 7/65; C09D 7/67; C09D 7/68; C09D 105/00

(57) ABSTRACT

The present invention is generally directed to fire retardant compositions containing one or more fire retardants, one or more polymers (e.g., one or more biopolymers such as xanthan gum) and colloidal silica. Certain aspects of the present invention are directed to liquid fire retardant concentrate compositions that form a durable (e.g., water-resistant) barrier when applied. The compositions of the present invention optionally include micronized clay. The present invention is also directed to various other compositions, which may be referred to as water-resistant film forming compositions that contain one or more polymers (e.g., one or more biopolymers such as xanthan gum) and colloidal silica. The present invention is also directed to such compositions containing micronized clay and colloidal silica. A water-resistant barrier formed by the compositions of the present invention provide compositions suitable for use in a variety of other applications, in addition to fire retardant compositions.

### FIELD OF THE INVENTION

The present invention is generally directed to fire retardant compositions containing one or more fire retardants, one or more polymers (e.g., one or more biopolymers such as xanthan gum) and colloidal silica. Certain aspects of the present invention are directed to liquid fire retardant concentrate compositions that form a durable (e.g., water-resistant) barrier when applied. The compositions of the present invention optionally include micronized clay. The present invention is also directed to various other compositions, which may be referred to as water-resistant film forming compositions that contain one or more polymers (e.g., one or more biopolymers such as xanthan gum) and colloidal silica. The present invention is also directed to such compositions containing micronized clay and colloidal silica. A water-resistant barrier formed by the compositions of the present invention provide compositions suitable for use in a variety of other applications, in addition to fire retardant compositions.

### BACKGROUND OF THE INVENTION

Typically, fire retardants used on wildfires are water soluble and are only effective until washed away by precipitation, excessive wind, or regrowth of vegetation. Accordingly, a need exists for fire retardant composition that address these issues, which could be provided by durable (e.g., water-resistant) fire retardant composition.

More generally, hydrogels are polymeric materials including hydrophilic polymer chains that allow them to contain a large amount of water in their three-dimensional networks. Hydrogels are currently believed to be desirable for use in a variety of applications based on their high capacity of water absorption and high gel strength. Hydrogels are effective for use in a variety of medical, agricultural, and industrial applications. These include, for example, hygienic products, drug delivery systems, pharmaceutical compositions, biomedical applications, tissue engineering, regenerative medicines, diagnostics, wound dressing, agricultural compositions, and food additives. Other, water-resistant film-forming compositions, though not necessarily “hydrogels” may also be effective for a variety of applications.

### BRIEF SUMMARY OF THE INVENTION

Briefly, therefore, the present invention is directed to a liquid fire retardant concentrate composition, the composition comprising: one or more fire retardants; a biopolymer; colloidal silica particles; and micronized clay.

The present invention is also directed to a liquid fire retardant concentrate composition, the composition comprising: one or more fire retardants, the one or more fire retardants comprising monoammonium phosphate (MAP) and diammonium phosphate (DAP); a biopolymer, wherein the biopolymer is selected from the group consisting of polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof; colloidal silica particles; micronized clay, wherein the micronized clay is selected from the group consisting of attapulgite clay, kaolinite clay, halloysite clay, bentonite clay, sepiolite, and combinations thereof; and wherein: the MAP and DAP are each present in a concentration of from about 10 wt % to about 40 wt %; the biopolymer is present in a concentration of from about 0.5 wt % to about 1.5 wt %; the colloidal silica particles are present in a concentration of from about 6 wt % to about 12 wt %; and the micronized clay is present in a concentration of from about 1 wt % to about 3 wt %.

The present invention is further directed to a water-resistant film-forming composition, wherein the composition comprises water, a thickener, and colloidal silica. In various embodiments, the thickener is selected from the group consisting of polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof; the thickener is present in a concentration of from about 0.2 wt % to about 0.35 wt %; colloidal silica is present in a concentration of from about 2 wt % to about 2.5 wt %; the thickener and colloidal silica are present in a weight ratio (thickener:silica) of from about 0.01:1 to about 0.15:1; and water constitutes at least about 95 wt % of the composition.

Other objects and features will be in part apparent and in part pointed out hereinafter.

### DETAILED DESCRIPTION OF THE INVENTION

The present invention is generally directed to various compositions containing one or more thickeners, typically a naturally-occurring or synthetic polymer along with various other components (e.g., colloidal silica). Generally, therefore, the present invention involves compositions containing what may be referred to as a thickening component a polymer (e.g., a synthetic polymer or a naturally-occurring polymer). In various embodiments, the compositions of the present invention may be in the form of a “hydrogel” composition, exhibiting certain properties. In certain other embodiments, compositions of the present invention have been shown to provide a durable layer, or film when applied (e.g., a water-resistant layer) and, thus, may be referred as water-resistant film-forming compositions. It is to be understood that reference to a hydrogel herein does not exclude the possibility that the composition may also be referred to as a film-forming composition.

Suitable synthetic polymers include polyethylene glycol.

Suitable naturally-occurring, or biopolymers including various proteins, lipids, polysaccharides (carbohydrates).

Suitable proteins include animal-based proteins such as phosphoproteins (e.g., casein), globular proteins (e.g., albumin), and collagen-based proteins (e.g., gelatin).

Suitable lipids including plant-based lipids such as triglycerides (e.g., castor oil).

Suitable polysaccharides include those which are animal-based, fungal-based, bacterial-based, plant-based, and algae-based.

Suitable animal-based polysaccharides include chitins such as chitosan.

Suitable fungal-based polysaccharides include gums such as pullulan.

Suitable bacterial-based polysaccharides include gums such as dextran, xanthan gum, gellan gum, welan gum, and diutan gum.

Suitable plant-based polysaccharides include starches, cellulose, and gums. Suitable starches include arrowroot starch, corn starch, yucca starch, and pectin. Suitable celluloses include carboxymethyl cellulose, methyl cellulose, hydroxypropyl methyl cellulose, and hydroxyethyl cellulose. Such suitable gums include konjac, guar gum, acacia gum, locust bean gum, and tragacanth gum.

Suitable algae-based polysaccharides include galactans (e.g., agar agar and carrageenan) and alginates (e.g., alginic acid, calcium alginate, and sodium alginate).

Various aspects of the present invention, therefore, are directed to hydrogel compositions including one or more of the above polymers, along with various other components and suitable for use in a variety of applications, including in fire retardant compositions and in a variety of medical, agricultural, and industrial applications.

Various particular aspects of the present invention will be described herein in the following discussion.

### Fire Retardant Compositions

One aspect of the present invention is directed to fire retardant compositions containing one or more fire retardants, a polymer(s) disclosed herein, colloidal silica, and optionally micronized clay. Thus, in various embodiments, a fire retardant composition of the present invention comprises one or more components selected from polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof. One particular aspect of the present invention is directed to fire retardant compositions containing one or more fire retardants, xanthan gum, colloidal silica, and optionally micronized clay. The present invention involves fire retardant concentrate compositions and fire retardant solutions. It is currently believed that the fire retardant compositions of the present invention form a water resistant barrier and are capable of coating fuel and rendering the fuel durable and resistant to other elements that would normally render the fire retardant ineffective. These elements include, for example, precipitation, excessive wind, and regrowth of vegetation. Accordingly, various aspects of the present invention are directed to methods for wildfire prevention through preventive treatment of landscapes with the compositions of the present invention, in particular high-risk landscapes.

It is currently believed the fire retardant compositions of the present invention described therein (e.g., including xanthan gum, etc. in certain proportions) exhibit the desirable properties described above, in particular providing a durable, water-resistant film. Without being bound by any particular theory, it is currently believed at least a portion of the compositions of the present invention may include an aqueous medium and other components (e.g., xanthan gum, colloidal silica, and optionally micronized clay) present in the overall form of a “hydrogel” Although the presence of a hydrogel is currently believed to provide advantageous properties, the present invention is not limited to compositions where all or a portion of the composition is present in the form of a hydrogel. More generally, as noted above, the compositions of the present invention (including fire retardant compositions) may be in the form of a film-forming composition, in particular a composition suitable for forming a durable, water-resistant film For example, the compositions of the present invention may include xanthan gum (or other polymer present in the composition) cross-linked by colloidal silica particles, with at least a portion of the cross-linking bonds currently believed to be covalent.

It is currently believed the compositions of the present invention may provide lower cost options based on the relatively low cost of its components (e.g., water and xanthan gum) and may provide greater stability and durability (e.g., effectiveness for a longer time) than other fire retardant compositions.

It is further currently believed the compositions of the present invention provide protection against an undefined amount of precipitation and also wind because of the enhanced coating formed on the fuel by the water-resistant composition. This enhanced coating could provide extended coverage as compared to traditional fire retardants. For example, the compositions of the present invention could provide longer coverage (e.g., throughout the entire fire season). Accordingly, the compositions could be used for a few applications or a single application at the beginning of the fire season to prevent the spread of fires without the need for several applications to provide continuous coverage as with traditional fire retardants.

Although xanthan gum is known for use in wildland fire retardants (e.g., as a rheology modifier), the formation of a durable, water-resistant composition by the combination of xanthan gum and colloidal silica was surprising. For example, it was surprising that combining xanthan gum and colloidal silica in the concentrations and relative proportions described herein provided a durable water-resistant composition.

Although described herein as durable, water-resistant and contributing to superior performance, even in the absence of these properties the compositions of the present invention provide significant advantages. For example, the compositions provide ease in preparation and processing by virtue of being water-based and also use a relatively low proportion of chemicals. In this manner, the present compositions provide advantages in terms of toxicity and environmental impact.

Aspects of the present invention are directed to fire retardant concentrate compositions generally containing a biopolymer, colloidal silica, water, and one or more fire retardants. Further in accordance with such compositions, micronized clay is optionally also included.

Although portions of the following discussion specifically refer to xanthan gum, other biopolymers may be suitable as well. In various embodiments, the biopolymer is selected from any or all of the other biopolymers listed above and one or more biopolymers selected from guar gum, dextran, welan gum, gellan gum, diutan gum, pullulan, algin, collagen, casein, albumin, castor oil, cornstarch, arrowroot, yuca starch, carrageenan, konjac, alginate, gelatin, agar, pectin, cellulose gum, acacia guar gum, locust bean gum, acacia gum, gum tragacanth, glucomannan, alginic acid, sodium alginate, potassium alginate, ammonium alginate, calcium alginate, chitosan, carboxymethyl cellulose (CMC), methyl cellulose (MEC), hydroxyethyl cellulose (HEC), hydroxymethyl cellulose (HMC), hydroxypropyl methylcellulose (HPMC), ethylhydroxyethyl cellulose, and combinations thereof. In certain embodiments, the biopolymer is selected from diutan gum, welan gum, and hydroxyethyl cellulose.

As noted above, without being bound by a particular theory it is currently believed the compositions of the present invention may include a hydrogel formed from xanthan gum and water, along with colloidal silica particles. It is currently believed the colloidal silica particles participate in xanthan cross-linking, which could conduce hydrogel formation.

The compositions of the present invention are currently believed to form a water-resistant barrier. Fire retardant compositions of the present invention have been subjected to drip tests where film samples of the composition have shown resistance to damage over the course of testing. Generally, durability testing of compositions of the present invention involves forming a film of the composition and determining the amount of water required to break through a film formed from solutions drawn down on a glass plate and allowed to dry. Once the film is dry, the plate is placed under a burette filled with water and the valve of the burette was completely opened to create a uniform stream of water. The glass plate is tilted away from the outlet of the burette and oriented at an angle of 55° defined by a plane parallel to the outlet of the burette valve and the glass plate. The outlet of the burette valve is located 15 millimeters (mm) from the point of contact with the plate and the water is released from the burette at a rate of approximately 3 milliliters per second (mL/sec). The volume of water required to break through the film is recorded.

The current belief in the presence of a hydrogel is based at least in part on these test results. In any case, and irrespective of the presence of a hydrogel these results are believed to indicate a composition that exhibits advantageous properties for use as a fire retardant composition.

The fire retardant concentrate compositions of the present invention may be liquid or solid. Where liquid, the concentrate compositions may include the xanthan gum, silica, and optional micronized clay components in the proportions detailed herein and it is currently believed a hydrogel is formed in the concentrate composition containing a certain proportion of water and/or in the final diluted solution prepared for application. Where solid, the concentrate compositions contain xanthan gum, particulate silica, and optional micronized clay in the proportions detailed herein. It is currently believed a hydrogel is formed upon dilution to form an intermediate, liquid concentrate composition (e.g., a liquid concentrate composition exhibiting any or all of the properties detailed herein) and/or in the final diluted solution prepared for application.

### Xanthan Gum

Xanthan gum is present in liquid concentrate compositions in a proportion of at least about 0.5 wt %, at least about 1 wt %, at least about 1.5 wt %, at least about 2 wt %, or at least about 4 wt % of the composition. Generally, xanthan gum is present in liquid compositions in a proportion of from about 0.5 wt % to about 7.5 wt %, from about 0.5 wt % to about 6 wt %, or from about 0.5 wt % to about 4 wt % of the composition. Typically, xanthan gum is present in liquid compositions in a proportion of from about 0.5 wt % to about 2 wt %, from about 1 wt % to about 1.5 wt %, or from about 1.1 wt % to about 1.3 wt % of the composition.

Xanthan gum is present in solid compositions in a proportion of at least about 1 wt %, at least about 2 wt %, at least about 3 wt %, at least about 4 wt %, or at least about 5 wt % of the composition. Generally, xanthan gum is present in solid compositions in a proportion of from about 1 wt % to about 10 wt %, or from about 2 wt % to about 8 wt %.

Suitable sources of xanthan gum include Kelco KELTROL, KELZAN, and XANVIS gums, Archer Daniels Midland (ADM) NOVAXAN 200 FG and OPTIXAN gums, and other commercially available sources.

### Biopolymers

Other biopolymer(s) (e.g., any of those set forth in the lists above) may be incorporated in liquid concentrate compositions in a proportion of at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.5 wt %, at least about 2 wt %, or at least about 4 wt % of the composition. Generally, other biopolymer(s) are present in liquid compositions in a proportion of from about 0.5 wt % to about 7.5 wt %, from about 0.5 wt % to about 6 wt %, or from about 0.5 wt % to about 4 wt % of the composition. Typically, biopolymer(s) are present in liquid compositions in a proportion of from about 0.5 wt % to about 2 wt %, from about 1 wt % to about 1.5 wt %, or from about 1.1 wt % to about 1.3 wt % of the composition. For example, in certain embodiments, the biopolymer(s) may be incorporated in a proportion, or concentration of from about 0.5 wt % to about 1.5 wt %, from about 0.6 wt % to about 1.4 wt %, or from about 0.8 wt % to about 1.2 wt %. It is to be understood the biopolymers listed herein may be incorporated in these proportions alone, along with xanthan, and/or along with any of the other biopolymers.

### Particulate Silica

Generally, silica is incorporated in compositions of the present invention in particulate form. As detailed herein, various compositions of the present invention are liquid (e.g., fire retardant concentrate compositions and fire retardant solutions after dilution for application) while others are solid (e.g., powdered). In liquid compositions, typically colloidal silica containing suspended particulate silica is utilized. Typically, the colloidal silica has a surface area (Brunauer-Emmett-Teller (BET)) of from about 125 m²/g to about 300 m²/g, or from about 130 m²/g to about 260 m²/g. Additionally, or alternatively, the colloidal silica has a particle size of from about 30 to about 500 nanometers (nm) in diameter. It is currently believed that compositions of the present invention may include the biopolymer cross-linked by colloidal silica particles.

Generally, silica utilized in accordance with the present invention can be characterized as negatively charged, positively charged, or having a neutral surface charge. Suitable sources of colloidal silica include those commercially available from Grace, including LUDOX TM50, LUDOX TMA, LUDOX HSA, and LUDOX AM, and those commercially available from Nouryon, including LEVASIL CS30-425, CS40-614P, CS50-120, CS34-720, CS40-213, CS50-28, SP3088D, CC401 and other commercially available sources.

Overall, colloidal silica may be present in a proportion of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, or at least about 1 wt %. Often, the colloidal silica is present in a proportion of from about 0.5 wt % to about 10 wt % of the composition, from about 0.5 wt % to about 7.5 wt %, or from about 0.5 wt % to about 5 wt %).

In solid compositions, particulate silica may be present in a proportion of at least about 0.5 wt %, at least about 1 wt %, or at least about 5 wt %. Often, particulate silica is present in a proportion of from about 1 wt % to about 15 wt %, or from about 1 wt % to about 10 wt %.

Suitable solid, particulate sources of silica include fumed silicas and other silicas that may have been subjected to one or more surface treatments.

Generally, xanthan gum and colloidal silica are present in a weight ratio of xanthan gum to colloidal silica of from about 1:0.1 to about 1:20, from about 1:0.4 to about 1:20, or from about 1:0.4 to about 1:15. In various aspects of the present invention, the weight ratio of xanthan gum to colloidal silica is between 1:5 and 1:10. Typically, the weight ratio of xanthan gum to colloidal silica is from about 1:6 to about 1:9, or from about 1:7 to about 1:8.

In still further embodiments, colloidal silica particles may be incorporated into the fire retardant compositions in higher proportions at or near the upper end of the above-noted ranges including, for example, concentrations of at least about 5 wt %, at least about 6 wt %, at least about 7 wt %, or at least about 8 wt %. For example, colloidal silica particles may be present in a proportion of from about 5 wt % to about 12 wt %, from about 6 wt % to about 10 wt %, or from about 8 wt % to about 10 wt %. Overall, the ratio of biopolymer to colloidal silica particles may be from about 1:6 to about 1:9, or from about 1:7 to about 1:8.

### Micronized Clay

Optionally, a further component of the fire retardant compositions of the present invention is micronized clay. It is currently believed the primary function of the micronized clay involves aiding in suspension of the fire retardant component present in a liquid-containing fire retardant composition (e.g., a fire retardant concentrate composition suspended throughout a hydrogel including xanthan gum and colloidal silica).

The micronized clay is selected from the group consisting of attapulgite clay, kaolinite clay, halloysite clay, bentonite clay, sepiolite, and combinations thereof.

Generally, micronized clay is present in liquid compositions in a proportion of at least about 0.5 wt %, at least about 1 wt %, from about 1 wt % to about 3 wt %, or from about 1.5 wt % to about 2.5 wt %.

Solid compositions may contain micronized clay in a proportion of at least about 0.5 wt %, or from about 0.5 wt % to about 5 wt %.

The weight ratio of xanthan gum to micronized clay is typically from about 1:3 to about 1:0.6.

The weight ratio of micronized clay to colloidal silica particles is typically from about 1:3 to about 1:4.

### Fire Retardants

Suitable fire retardants for use in compositions of the present invention include those generally known in the art. These include, for example, monoammonium phosphate (MAP), diammonium phosphate (DAP), ammonium polyphosphate (APP), and magnesium chloride. In various embodiments, the fire retardant is selected from the group consisting of monoammonium phosphate (MAP), diammonium phosphate (DAP), ammonium polyphosphate (APP), magnesium chloride, and combinations thereof. In various embodiments, the fire retardant component comprises MAP and/or DAP. In still other embodiments, the fire retardant component comprises magnesium chloride.

In various embodiments of the present invention, the concentrate includes a fire retardant component solubilized along with the other components. In other embodiments the fire retardant component may be suspended throughout the concentrate composition. Descriptions of the concentrate appearing herein apply to concentrates whether the fire retardant component is solubilized or suspended. Fire retardant solutions prepared by diluting concentrate compositions may be prepared from concentrate compositions having the fire retardant component solubilized or suspended.

As noted, compositions of the present invention may be in liquid form or solid form. Liquid compositions include liquid concentrate compositions and solutions for application prepared by diluting concentrate compositions. Solid compositions include particulate (e.g., powdered) concentrate compositions. The solid compositions may first be diluted to first provide a liquid concentrate composition (i.e., an intermediate concentrate composition) followed by dilution prior to use to provide a diluted solution. Alternatively, the solid composition may be diluted to form the solution for application.

### Liquid Fire Retardant Concentrate Compositions

Any of the liquid fire retardant concentrate compositions provided herein can comprise at least one ammonium phosphate. In certain embodiments, the ammonium phosphate comprises, consists essentially of, or consists of monoammonium phosphate (MAP). In other embodiments, the ammonium phosphate comprises, consists essentially of, or consists of diammonium phosphate (DAP). In still other embodiments, the ammonium phosphate comprises, consists essentially of, or consists of ammonium polyphosphate (APP). In some embodiments, the liquid fire retardant concentrate compositions provided herein comprise a mixture of ammonium phosphates. In even further embodiments, the fire retardant includes magnesium chloride.

In some embodiments, a fire retardant concentrate is provided, the composition comprising a mixture of ammonium phosphates, the mixture of ammonium phosphates comprising monoammonium phosphate (MAP) and diammonium phosphate (DAP). The suspending agent preferably comprises micronized clay.

In additional embodiments, a fire retardant concentrate is provided, the composition comprising one or more ammonium phosphates, a suspending agent and water. In certain embodiments, the composition comprises MAP, DAP, and/or APP. In certain other embodiments, the composition includes a mixture of ammonium phosphates comprising monoammonium phosphate (MAP) and diammonium phosphate (DAP). In additional embodiments, the fire retardant is magnesium chloride. Preferably, the water constitutes less than 50% by volume of the concentrate composition. In some embodiments, for example, the water can comprise about 40% to 50% by weight of the concentrate composition. Typically, the composition comprises at least about 25 wt %, at least about 30 wt %, at least about 35 wt %, or at least about 40 wt % water. By way of further example, the composition may comprise from about 25 wt % to about 50 wt % or from about 35 wt % to about 45 wt % water.

In still further embodiments, a fire retardant concentrate is provided, the composition comprising a mixture of ammonium phosphates and wherein the fire retardant does not contain a separate sulfate source and is characterized as having a low sulfate content. Sulfates are usually detectable in liquid fire retardant concentrates for two reasons. First, ammonium polyphosphates (usually used as the fire retardant) contain a minimum amount of sulfates (usually up to 2%, see for example, 11-37-0 Ammonium Polyphosphate Solution, LIQUID PRODUCTS LLC). Second, some fire retardant formulations comprise diammonium sulfate. These two sources of sulfates may result in liquid concentrates having reduced potency and efficacy, which increases their corrosiveness and toxicity as more fire retardant component (and more ammonia) is required to have the same fire retardant effect.

In accordance with the present invention, the fire retardant concentrates can be prepared using technical grade MAP and DAP which include low levels of detectable sulfates. For example, certain compositions of the present invention contain less than about 1% by total weight, less than about 0.5% by total weight, or less than about 0.4% by total weight sulfates. Often, the compositions contain even lower levels of sulfates such as, for example, less than about 0.3% by total weight, less than about 0.2% by total weight of sulfates, or even lower. In other instances, the concentrates can be prepared using fertilizer grade MAP and DAP which can contain higher levels of sulfates of up to about 5% by total weight, or even higher (e.g., about 6% by total weight).

In various embodiments, the composition includes a mixture of ammonium phosphates, typically at least two ammonium phosphates. In certain embodiments, the mixture of ammonium phosphates comprises, consists essentially of, or consists of monoammonium phosphate (MAP) and diammonium phosphate (DAP). In certain embodiments, the MAP contains from about 10% or 11% to about 12% ammonia by weight and from about 40% or 55% to about 61% phosphorus pentoxide by weight. In certain embodiments, the DAP contains from about 16% to about 21% ammonia by weight and from about 40% to about 54% phosphorus pentoxide by weight. Further, in certain embodiments, the weight ratio of MAP to DAP is in the range of from about 5% to about 60% MAP to about 40% to about 95% DAP of the total ammonium phosphate in the concentrate. In certain embodiments, the weight ratio of MAP to DAP is in the range of from about 40% to about 60% MAP to about 40% to about 60% DAP of the total ammonium phosphate in the concentrate. In certain embodiments, the weight ratio of MAP to DAP is in the range of from about 50% to about 60% MAP to about 40% to about 50% DAP of the total ammonium phosphate in the concentrate.

In further embodiments, the composition comprises from about 19% to about 50% by weight of DAP. The composition can comprise from about 19% to about 47% by weight of DAP. For example, the composition can comprise from about 20% to 30% of DAP. In some instances, the composition comprises from about 25% to about 27% by weight of DAP (e.g., about 26%).

In further embodiments, the composition comprises from about 1% to about 30% of MAP. The composition can comprise from about 10% to about 30% of MAP. For example, the composition can comprise from about 20% to about 30% by weight of MAP. In some instances, the composition comprises from about 22% to about 24% by weight of MAP (e.g., about 23%).

As noted above, in accordance with the present invention various embodiments incorporate the MAP and DAP within certain preferred ratios to enhance solubility of the ammonium phosphates. Therefore, in certain embodiments, the weight ratio of MAP to DAP is from about 40:60 to about 60:40, or from about 45:55 to about 55:45 (e.g., about 46:54 or about 47:53).

In certain embodiments, the APP contains from about 12% to about 17% ammonia by weight and from about 68% to about 75% phosphorus pentoxide by weight. Further, in certain embodiments, the weight ratio of APP to MAP and/or DAP is in the range of from about 5% to about 60% APP to about 40% to about 95% MAP and/or DAP of the total ammonium phosphate in the concentrate. In certain embodiments, the weight ratio of APP to MAP and/or DAP is in the range of from about 40% to about 60% APP to about 40% to about 60% MAP and/or DAP of the total ammonium phosphate in the concentrate. In certain embodiments, the weight ratio of APP to MAP and/or DAP is in the range of from about 50% to about 60% APP to about 40% to about 50% MAP and/or DAP of the total ammonium phosphate in the concentrate.

In further embodiments, the composition comprises from about 1% to about 95% by weight, from about 1% to about 85% by weight, from about 1% to about 75% by weight, or from about 1% to about 60% by weight of APP. The composition can comprise from about 10% to about 50% by weight of APP. For example, the composition can comprise from about 10% to 40% of APP. In some instances, the composition comprises from about 10% to about 30% by weight of APP (e.g., about 20%).

Further, whether incorporated alone or along with one or more other fire retardants, the ammonium polyphosphate may be characterized by its chain length. Suitable APP fire retardants for use in powder form typically have a chain length with a value of at least about 100, at least about 500, or at least about 1000. Typically, the chain length for powder APP fire retardants is from about 100 to about 1500, or from about 100 to about 1000.

When prepared as a liquid concentrate, the fire retardant component (e.g., the mixture of ammonium phosphates) typically constitutes less than about 95% by weight, less than about 85% by weight, or less than about 75% by weight of the composition (e.g., from about 40% to about 60% by weight of the composition).

In some embodiments, water constitutes less than 50% by volume of the concentrate composition. Typically, the water constitutes about 10 to 50% by weight of the total concentrate composition. More typically, the water constitutes about 30% to about 50% by weight of the total concentrate or from about 40% to about 50% by weight of the total concentrate composition.

### Corrosion Inhibitors

The fire retardant concentrate compositions can also comprise a corrosion inhibitor.

In certain embodiments, the corrosion inhibitor comprises a biopolymer. Representative examples of biopolymers include xanthan gum, rhamsan gum, welan gum, diutan gum and mixtures thereof. It is believed that such biopolymers impact both the rheological properties and the corrosion properties of the fire retardant solutions. In certain embodiments, the corrosion inhibitor system can comprise a micronized clay complexed with diammonium phosphate (DAP), a molybdate corrosion inhibitor, an azole corrosion inhibitor, a pyrophosphate or any combination thereof.

In some embodiments, the corrosion inhibitor comprises a micronized clay complexed with diammonium phosphate (DAP) and/or monoammonium phosphate (MAP). These clays have an affinity for both MAP and DAP such that the phosphates can intercalate in the lattice of the material. When the fire retardant concentrate composition comprises, a micronized clay complexed with DAP and/or MAP as the corrosion inhibitor, the composition can be understood to contain both “free” (from the dissolved fire retardant) DAP and/or MAP and “complexed” (from the micronized clay) DAP and/or MAP. Although the complexed DAP and/or MAP cannot act as a fire retardant in the complexed state, when the concentrate is diluted to prepare a fire retardant solution as described below, the excess water helps release and dissolve the complexed DAP and/or MAP, thus converting it to free DAP and/or MAP and increasing the efficacy of the overall fire retardant solution. Thus, using micronized clay complexed with DAP and/or MAP as a corrosion inhibitor can provide the dual benefit of decreasing corrosion and increasing levels of DAP and/or MAP above and beyond the limits of solubility in the concentrated form, thus increasing the strength of the overall concentrate. In some embodiments therefore, the ratio of free DAP to complexed DAP is about 90:10. For example, the ratio of free DAP to complexed DAP can be about 95:5. In some embodiments, the ratio of free MAP to complexed MAP is about 90:10. For example, the ratio of free MAP to complexed MAP can be about 95:5. Suitable claims are commercially available from Applied Minerals Inc.

The corrosion inhibitor system can also comprise a molybdate corrosion inhibitor. In certain embodiments, the corrosion inhibitor system comprises anhydrous sodium molybdate, its dihydrate, or mixtures thereof. In certain embodiments, the amount of anhydrous sodium molybdate, its dihydrate, and mixtures thereof is from about 0.01% to about 2.0% by weight of the total concentrate concentration. In certain embodiments, the amount of anhydrous sodium molybdate, its dihydrate, mixtures thereof is from about 0.05% to about 0.3% by weight of the total concentrate concentration. In certain embodiments, the amount of anhydrous sodium molybdate, its dihydrate, and mixtures thereof is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition. In certain embodiments, the corrosion inhibitor constitutes at least about 0.01 wt %, from about 0.01 wt % to about 1 wt %, or from about 0.01 wt % to about 0.5 wt %.

The corrosion inhibitor system can also comprise an azole corrosion inhibitor. In certain embodiments, the azole corrosion inhibitor comprises tolytriazole and/or benzotriazole. Preferably, the azole corrosion inhibitor comprises tolytriazole. In certain embodiments, the amount of the azole corrosion inhibitor is from about 0.01% to about 2.0% by weight of the total concentrate concentration. In certain embodiments, the amount of the azole corrosion inhibitor is from about 0.05% to about 0.3% by weight of the total concentrate concentration. In certain embodiments, the amount of the azole corrosion inhibitor of is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

In some embodiments, the corrosion inhibitor can comprise a molybdate corrosion inhibitor and an azole corrosion inhibitor (for example, sodium molybdate and tolytriazole). The corrosion inhibitor system can constitute from about 0.02% to about 4% by weight of the total concentrate composition. Often, the corrosion inhibitor system constitutes from about 0.02% to about 4% by weight of the total concentrate composition when two or more corrosion inhibitors are used (for example, sodium molybdate and tolytriazole).

### Pigments/Dyes and Opacifiers

In some embodiments, the liquid fire retardant concentrate is prepared as an uncolored formulation. However, in other embodiments, the liquid fire retardant concentrate can comprise a pigment or a dye. In certain aspects, the pigment or dye comprises red iron oxide, brown iron oxide, titanium dioxide or a fugitive pigment or dye. In some embodiments, the pigment or dye can comprise a fugitive color system.

The pigment or dye can be magenta in color. In certain embodiments, the pigment or dye is UV sensitive. In certain embodiments, the pigment or dye is formaldehyde-free. In certain embodiments, the pigment or dye is a fluorescent pigment or dye. In certain embodiments, the pigment or dye has a Lab color spacing of “L” in a range from about 34 to about 89, “a” in a range from about 18 to about 83 and “b” in a range from about-61 to about 56. The LAB color space model was developed by the International Commission of Illumination (CIE) and is one convention of describing colors. The model has a 3 axis system. The L* represents the lightness and is on the vertical axis. The “0” on bottom of the vertical axis indicates the absence of light. The maximum lightness is on the top “100”. The a* is on the horizontal axis indicating red (−a) to green (a+). The b* is on the horizontal axis indicating blue (−b) to yellow (+b). The center of the axis is neutral. (See, for example, www.colourphil.co.uk/lab_lch_colour_space.shtml.)

In certain embodiments, the liquid fire retardant concentrate comprises a fugitive color system. Preferably, the liquid concentrate comprising the fugitive color system is storage-stable and results in little to no loss of color over long storage. The fugitive color system can comprise a fugitive color pigment. The fugitive color pigment can exhibit hydrophilic or diminished hydrophobic tendencies. In certain instances, the fugitive color pigment is fluorescent. The fugitive color pigments that may be incorporated into the liquid concentrates described herein may be significantly easier to wet, incorporate, disperse and or homogenize within the liquid concentrate compared to other color pigments.

In some embodiments, the fugitive color system comprises a fugitive pigment and a water insoluble opaque material (e.g., an opacifier). The fugitive pigment comprises a dye encapsulated within a polymeric material. One purpose for encapsulating the dye within the polymer material is so that the dye does not stain the people, equipment, etc. with which it comes into contact. In certain aspects, the polymeric material can be, for example, petroleum resins (CAS #64742-16-1), melamine (CAS #108-78-1), and the like as known to one of ordinary skill in the art. In certain aspects, the dye is a fluorescent dye. In certain aspects, the dye and the polymer work together to achieve fluorescence, e.g., the dye and resin combination comprising the fugitive pigment fluoresces. The fugitive pigment used in the concentrates herein preferably exhibits hydrophilic or reduced hydrophobic behavior in comparison to other fugitive pigments. In certain aspects, the fugitive pigment is hydrophilic. In certain aspects, the fugitive pigment is easy to incorporate into an aqueous media. In certain aspects, the fugitive pigment more easily incorporates into an aqueous media in comparison to a control fugitive pigment that does not exhibit hydrophilic behavior and/or is not hydrophilic. For example, a hydrophobic control fugitive pigment containing Solvent Red 1 dye CAS #1229-55-6, two hydrocarbon resins CAS #64742-16-1 and CAS #64742-94-5, and TiO₂ CAS #13463-67-7 opacifier, in the amounts of 80-88% resin, 7-10% dye, and 5-10% TiO2 opacifier.

An opaque material (e.g., an opacifier) is one that is neither transparent nor translucent and by “water insoluble,” it is meant that the water solubility is ≤5% as determined by the art established standard ISO 787-3, which is incorporated herein by reference in its entirety. In certain aspects, the water insoluble opaque material comprises a finely divided iron oxide pigment, zinc ferrite, tri-calcium phosphate, barium phosphate, or titanium dioxide. In certain aspects, the water insoluble opaque material comprises a finely divided iron oxide pigment. In certain aspects, the opacifier is in a minor amount. In certain aspects, the opacifier is in an amount of about 0.05% to about 4.0% (e.g., about 0.1% to about 0.8%) by weight of the total composition. In certain aspects, the fugitive colored liquid long-term fire retardant exhibits a hue optically visible to the human eye when applied as relatively thin (⅛th inch thick) films on the trees, brush, grasses, and mixtures thereof, that are encountered in wildland and other under developed fireprone rural areas.

In certain aspects, a fugitive pigment suitable for the concentrates herein, exhibiting hydrophilic behavior and/or a fugitive pigment that is hydrophilic is a fluorescent fugitive pigment. Representative fluorescent pigments useful in this disclosure are, for example, described in U.S. Pat. No. 5,439,968 “Fluorescent Pigment Concentrates,” which is incorporated herein by reference in its entirety for all relevant purposes.

In certain aspects, the fugitive pigment or dye is magenta. In certain aspects, the fugitive pigment or dye is a fluorescent magenta in color. In certain aspects, the fluorescent pigment or dye has a Lab color spacing of “L” in a range from about 34 to about 89, “a” in a range from about 18 to about 83, and “b” in a range from about-61 to about 56. It was observed that a magenta fluorescent fugitive pigment was an optimum colorant based on its visibility within the many colors found in wildland brush, timber, trees, grasses, etc. However, one of ordinary skill in the art will recognize that the fugitive pigments of this disclosure are not limited to magenta or fluorescent magenta.

In certain aspects, a fluorescent fugitive pigment is any one of the ECO Pigments manufactured by DayGlo Corporation. In certain aspects, the fluorescent fugitive pigment is ECO-20, Ultra Violet manufactured by DayGlo Corporation. In certain aspects, the fluorescent fugitive pigment is ECO-21, Corona Magenta manufactured by Day Glo Corporation (1-5 weight % C.I. Basic Violet 11, CAS-No. 2390-63-8 and 1-5 weight % C.I. Basic Red 1:1, CAS-No. 3068-39-1; melting/freezing point 145° C.-150° C.; specific gravity 1.2). In certain aspects, the fluorescent fugitive pigment is ECO-15, Blaze Orange manufactured by Day Glo Corporation. In certain aspects, the fluorescent fugitive pigment is ECO-14, Fire Orange manufactured by DayGlo Corporation. In certain aspects, the fluorescent fugitive pigment is ECO-13, Rocket Red manufactured by Day Glo Corporation. In certain aspects, the fluorescent fugitive pigment is ECO-11, Aurora Pink manufactured by Day Glo Corporation. In certain aspects, the fluorescent fugitive pigment is ECO-21, Corona Magenta manufactured by Day Glo Corporation

Thus, in some embodiments, the fire retardant concentrate compositions described herein can comprise a dye or pigment. In some embodiments, the dye or pigment comprises red iron oxide, brown iron oxide, or a fugitive pigment or dye. The fugitive pigment or dye can be magenta in color. In certain embodiments, the dye or pigment comprises a fugitive color system. The fugitive color system can, preferably, comprise a water insoluble opaque material and a fugitive pigment. The water insoluble opaque material can comprise ferric oxide, titanium dioxide, zinc ferrite, or any combination thereof. In embodiments, the water insoluble opaque material constitutes from about 0.05 to about 4% by weight of the total composition. The fugitive pigment can comprise a fugitive dye encapsulated within a polymeric material, exhibiting hydrophilic behavior. The fugitive pigment can be magenta in color. In embodiments, the fugitive pigment has a Lab color spacing of “L” in a range from about 34 to about 89, “a” in a range from about 18 to about 83, and “b” in a range from about-61 to about 56. In certain embodiments, the fugitive dye or pigment constitutes from about 1% to about 2% by weight of the total composition.

### Physical Properties of Liquid Concentrate

In certain embodiments, the liquid fire retardant concentrate composition described herein can have a density of from about 1.1 to about 1.5. Additionally, or alternatively, the compositions may exhibit a specific gravity of from about 1.0 to about 1.5, or from about 1.0 to about 1.4. In some embodiments, the liquid fire retardant concentrate can exhibit a viscosity of from about 50 centipoise (cP) to about 1500 cP (e.g, from about 50 cP to about 1000 cP), from about 100 cP to about 1500 cP, from about 100 cP to about 1000 cP, about 100 cP to about 800 cP, from about 100 cP to about 400 cP, or from about 100 cP to about 300 cP when measured in accordance with the methods described in Specification 5100-304d.

In some embodiments, the liquid fire retardant concentrate can have an acidic pH. For example, the liquid fire retardant concentrate can have a pH of from about 5 to 6 or from about 5.5 to about 6.5.

### Processes to Prepare a Liquid Fire Retardant Concentrate

Also described herein are methods for preparing a liquid fire retardant concentrate composition. Generally, the components may be added in any order to provide the final retardant concentrate composition.

Generally, xanthan gum is combined with water and the fire retardants. The micronized clay and colloidal silica typically are then added. Typically, the micronized clay is added, followed by the colloidal silica, while in on other embodiments the colloidal silica is added before the micronized clay. All other components (e.g., corrosion inhibitor, pigment, etc.) generally may be added at any point. In various embodiments, the additional components are added following xanthan gum addition and may be added alone or with either or both of the micronized clay and colloidal silica.

In various other embodiments, xanthan gum, colloidal silica, and micronized clay are combined with water concurrently. Any additional components may be added later or combined with water along with all other components.

Generally, the fire retardant composition exhibits an initial viscosity of from about 10 cP to about 400 cP upon preparation and 24 hours after storage.

In certain embodiments, the liquid fire retardant concentrate has a higher strength than comparative liquid fire retardant concentrates. For example, the liquid fire retardant concentrate can comprise a higher proportion of the fire retardant component (e.g., the ammonium phosphates) per unit volume. Consequently, less of the concentrate is required to make a fire retardant solution of equivalent strength to one prepared by other liquid concentrates. This results in a safer, less toxic, less corrosive and more economical fire retardant concentrate and solution compared to currently available options.

### Solid Fire Retardant Compositions

Generally, solid fire retardant concentrates of the present invention are particulate and typically in the form of a powder. In various embodiments the solid retardant is in the form of a flowable powder suitable for use in the field (e.g., suitable for mixing after periods of storage).

In various embodiments, the solid concentrates of the present invention include one or more of the fire retardants listed above in a proportion of at least about 75 wt %, at least about 80 wt %, at least about 85 wt %, or at least about 90 wt %. In various embodiments, the concentrates include from about 80 wt % to about 95 wt %, from about 85 wt % to about 95 wt %, or from about 90 wt % to about 95 wt %.

An additional component may be a flow conditioner. Generally, the flow conditioner is present in a proportion of at least about 0.1 wt %, at least about 0.25 wt %, at least about 0.5 wt %, at least about 0.75 wt %, at least about 1 wt %, at least about 1.25 wt %, at least about 1.5 wt %, at least about 2 wt %, at least about 3 wt %, or even at least about 4 wt %. In various embodiments, the flow conditioner is present in a proportion of from about 0.25 wt % to about 5 wt %, from about 0.25 wt % to about 4 wt %, from about 0.25 wt % to about 3 wt %, from about 0.5 wt % to about 2 wt %, from about 0.5 wt % to about 1.75 wt %, from about 0.75 wt % to about 1.5 wt %, or from about 1 wt % to about 1.5 wt.

The flow conditioner itself may be selected to address issues caused by the hygroscopic nature of the fire retardant. Suitable flow conditioners include tricalcium phosphate, silicon dioxide (silica, e.g., micronized silica), sodium alumino silicate, calcium silicate, aluminum silicate, cellulose, magnesium oxide, and mixtures thereof. In certain embodiments, the flow conditioner comprises tricalcium phosphate. Options of commercially available sources of flow conditioner include the following silicon dioxide flow conditioners: ZEOFREE 80, 110SD, 200, 5161, 5162, 265, 5191, 5193, and 5170. Options of commercially available calcium silicate flow conditioners include: HUBERSORB 5121, 250, and 600. Options of commercially available sodium aluminosilicate flow conditioners include: ZEOLEX 7, 201, 23A, and 7A.

The solid compositions may further comprise a corrosion inhibitor.

The corrosion inhibitor may comprise an azole corrosion inhibitor. In certain embodiments, the azole corrosion inhibitor comprises tolytriazole and/or benzotriazole. Often, the azole corrosion inhibitor comprises tolytriazole. In certain embodiments, the amount of the azole corrosion inhibitor is from about 0.01% to about 2.0% by weight of the total concentrate concentration. In certain embodiments, the amount of the azole corrosion inhibitor is from about 0.05% to about 0.3% by weight of the total concentrate concentration. In certain embodiments, the amount of the azole corrosion inhibitor of is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

The corrosion inhibitor may also comprise a molybdate corrosion inhibitor. In certain embodiments, the corrosion inhibitor system comprises anhydrous sodium molybdate, its dihydrate, or mixtures thereof. In certain embodiments, the amount of anhydrous sodium molybdate, its dihydrate, and mixtures thereof is from about 0.01% to about 2.0% by weight of the total concentrate concentration. In certain embodiments, the amount of anhydrous sodium molybdate, its dihydrate, mixtures thereof is from about 0.05% to about 0.3% by weight of the total concentrate concentration. In certain embodiments, the amount of anhydrous sodium molybdate, its dihydrate, and mixtures thereof is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

The corrosion inhibitor may also comprise an azole corrosion inhibitor and a molybdate corrosion inhibitor in accordance with the foregoing discussion for the individual corrosion inhibitors.

Further in accordance with the present invention it has been discovered that certain components may be desired to provide an improvement in viscosity and/or stability over time. Such components may be an azole stability enhancer (e.g., dimercaptothiadiazole (DMTD)).

Generally, any stability enhancing component is present in a proportion of at least about 0.1 wt %, at least about 0.2 wt %, at least about 0.3 wt %, at least about 0.4 wt %, or at least about 0.5 wt %. Typically, any stability enhancing component is present in a proportion of from about 0.1 wt % to about 1 wt %.

In some embodiments, the liquid fire retardant concentrate is prepared as an uncolored formulation. However, in other embodiments, the liquid fire retardant concentrate can comprise a pigment or a dye. In certain aspects, the pigment or dye comprises red iron oxide, brown iron oxide, titanium dioxide or a fugitive pigment or dye. In some embodiments, the pigment or dye can comprise a fugitive color system.

In some embodiments, the fugitive color system comprises a fugitive pigment and a water insoluble opaque material (e.g., an opacifier such as zinc ferrite).

Additionally, or alternatively, the solid compositions of the present invention may include any or all of the pigments and color systems listed above.

Further in accordance with the foregoing, the solid compositions of the present invention may include one or more components selected from a surfactant, foam controlling additive, and/or a biocide.

### Fire Retardant Solutions

Fire retardant solutions for application may readily be prepared from liquid and solid concentrate compositions of the present invention. Where prepared from liquid concentrate compositions, additional water is added to provide a solution of the desired composition. Where prepared from a solid concentrate composition, the solid composition may be initially diluted to form a liquid concentrate composition, which may be termed an “intermediate concentrate” followed by dilution to form the final solution for application.

Provided for herein are fire retardant solutions prepared by mixing a fire retardant concentrate composition, as described anywhere herein, with water to form an aqueous solution. In certain embodiments, a homogenous solution is formed. In certain embodiments, the water contains low levels of bacterial contamination that can impact viscosity and/or stability by consuming biopolymers. Thus, in certain embodiments, the water contains a biocide to prevent bacterial contamination. In certain embodiments, the solution comprises insoluble components.

In certain embodiments, the solution is prepared by combining at least 3 volumes of water per volume of liquid concentrate. In certain embodiments, the ratio of water to liquid concentrate is from about 3 volumes to about 7 volumes of water to about 1 volume of liquid concentrate (e.g., from about 5 volumes of water to about 7 volumes of water to about 1 volume of liquid concentrate). Often, the fire retardant solution is prepared by combining the fire retardant concentrate and water at a dilution rate of at least about 1.0 pound (lb.), at least about 1.5 lbs., or at least about 2 lbs. of fire retardant concentrate per gallon of water.

These dilution levels may result in a fire retardant solution having a lower density in comparison to prior fire retardant solutions with equivalent performance characteristics, which in turn, can either reduce the weight of a fully loaded aircraft or increase the volume that an aircraft is capable of carrying. This factor can reduce the hazards associated with aerial firefighting. Further the mix or dilution rate of the concentrate can be predetermined by evaluation of its performance in retarding the rate of flame spread and fuel consumption.

In certain embodiments, a fire retardant solution exhibits an aluminum corrosion rate equal to or less than 2.0 milli-inches or less than 1.0 milli-inches per year. In certain embodiments, a fire retardant solution exhibits a mild steel corrosion rate equal to or less than 5.0 milli-inches per year. In certain embodiments, a fire retardant solution exhibits a brass corrosion rate equal to or less than 5.0 milli-inches per year. In certain embodiments, a fire retardant solution exhibits two or more of the above described corrosion rates for magnesium, aluminum, mild steel and/or brass.

In certain embodiments, a fire retardant solution meets one or more of the required criteria for of U.S. Department of Agriculture, Forest Service, Specification Number 5100-304d, January 2020, including any and all amendments.

In certain embodiments, a fire retardant solution meets one or more of the required criteria for corrosion and/or stability of U.S. Department of Agriculture, Forest Service, Specification Number 5100-304d, January 2020, including all amendments.

In certain embodiments, a fire retardant solution meets all of the required criteria for corrosion of U.S. Department of Agriculture, Forest Service, Specification Number 5100-304d, January 2020, including all amendments.

In certain embodiments, a fire retardant solution meets all of the required criteria for stability of U.S. Department of Agriculture, Forest Service, Specification Number 5100-304d, January 2020, including all amendments.

In certain embodiments, a fire retardant solution meets all of the required criteria for corrosion and stability of U.S. Department of Agriculture, Forest Service, Specification Number 5100-304d, January 2020, including all amendments.

In certain embodiments, a fire retardant solution meets all of the required criteria of U.S. Department of Agriculture, Forest Service, Specification Number 5100-304d, January 2020, including all amendments.

In certain embodiments, the fire retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments.

The disclosed solutions also exhibit low aquatic toxicity. For example, in certain embodiments, a solution exhibits an aquatic toxicity (LC50) in the range of from about 180 milligrams per liter to about 1500 milligrams per liter. In certain embodiments, a solution exhibits an aquatic toxicity (LC50) greater than about 180, 200, 500, 1000, 2000, or 2500 milligrams per liter. In certain embodiments, a solution exhibits an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

In certain embodiments, a fire retardant solution has a pH in the range of from about pH 4.0 or 5.0 to about pH 8.0. In certain embodiments, a fire retardant solution has a pH in the range of from about pH 6.0 about pH 8.0. In certain embodiments, a fire retardant solution has a pH in the range of from about pH 6.0 to about pH 7.0. In certain embodiments, a fire retardant solution has a pH in the range of from about pH 6.0 to about pH 6.5. In certain embodiments, a fire retardant solution has a pH in the range of from about pH 6.1 to about pH 6.3. In certain embodiments, a fire retardant solution has an acidic pH.

In certain embodiments, visibility of the applied solution is improved, allowing firefighting forces to draw an effective chemical fire barrier using less total solution.

### Method of Combatting a Wildfire

Disclosed herein are methods of combatting a wildfire by applying a fire retardant solution described anywhere herein for the purpose of suppressing, containing, controlling, or extinguishing, etc., a wildfire. In certain embodiments, the fire retardant solution is applied directly onto a flaming fuel. In other embodiments, the fire retardant solution is applied indirectly, e.g., in front of or parallel to the moving fire front. The distance between the advancing fire and the retardant firebreak depends on the rate that the solution can be applied, the rate of spread of the moving fire front, and the presence or absence of a natural fuel break identified by changes in the geometry of the ground being threatened. In certain embodiments, the fire retardant solution is applied from a ground platform such as a fire engine. In certain embodiments, the fire retardant solution is applied from an aerial platform such as a fixed-wing aircraft or a rotary-wing aircraft. For example, in certain embodiments, the fire retardant solution is applied from a rotary-wing aircraft such as a helicopter utilizing a bucket which is slung below the helicopter and in other embodiments the fire retardant solution is contained within tanks mounted in or attached externally to the helicopter. In other embodiments, the fire retardant solution is applied from a mix of all of those listed vehicles or platforms. Obviously, the safety of the solution relative to aircraft corrosion and fouling of critical components must be greater when the solution is within or in contact with the aircraft.

### Film-Forming Compositions

Further aspects of the present invention are compositions that may take the form of a hydrogel but, in any case, are currently believed to form a durable film, or layer (e.g., a water-resistant barrier) and, therefore, are suitable in applications other than fire retardant compositions including, for example, in pharmaceutical applications and agricultural applications (e.g., to provide controlled and/or slower release fertilizers or agricultural chemicals and reduce run off).

As with fire retardant concentrate compositions, it is currently believed the compositions of the present invention may provide lower cost options in the applications listed above based on the relatively low cost of its components and may provide greater stability and durability (e.g., effectiveness for a longer time) than other, hydrogel-based compositions.

Various aspects of the present invention are also directed to compositions (e.g., hydrogel compositions and durable, water-resistant film-forming compositions) containing one or more thickeners, typically a naturally-occurring or synthetic polymer along with various other components (e.g., colloidal silica) from the classes set forth above. In particular, various compositions may include a synthetic polymer or a naturally occurring, biopolymer. These include various suitable proteins, including animal-based proteins such as phosphoproteins, globular proteins, and collagen-based proteins. Other suitable polymers include lipids, such as plant-based lipids and various polysaccharides, including those which are animal-based, fungal-based, bacterial-based, plant-based, and algae-based.

Generally, various aspects of the present invention involve compositions containing one or more of the biopolymers listed above, in particular, polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof.

Typically, these compositions contain the biopolymer, or thickener at a concentration of at least or about 0.05 wt %, at least or about 0.1 wt %, at least or about 0.15 wt %, at least or about 0.2 wt %, at least or about 0.25 wt %, at least or about 0.28 wt %, at least or about 0.3 wt %, or within a range of concentration defined by these concentrations as upper and lower limits. For example, in certain embodiments, the biopolymer, or thickener may be present in a concentration of from about 0.2 wt % to about 0.35 wt % (e.g., about 0.05 wt % or about 0.28 wt %).

The silica (typically colloidal silica) is typically present in a concentration range of at least or about 2 wt %, at least or about 2.05 wt %, at least or about 2.1 wt %, at least or about 2.15 wt %, at least or about 2.2 wt %, at least or about 2.5 wt %, or within a concentration range defined by these concentrations as upper and lower limits.

Typically, the biopolymer (thickener) and silica are included in weight ratio (thickener:silica) of from about 0.01:1 to about 0.15:1 (e.g., about 0.01:1 or about 0.13:1).

Along with the thickener and silica, the primary component of these hydrogels is water, typically at a concentration of at least about 97 wt %, at least about 97.5 wt %, or at least about 98 wt %.

The viscosity of these compositions is typically at least or about 3 centipoise (cP), at least or about 5 cP, at least or about 10 cP, at least about 15 cP, at least or about 20 cP, at least or about 25 cP, at least or about 30 cP, at least or about 35 cP, at least or about 40 cP, or within a range defined by these values as limits.

The density (g/mL) of these compositions is typically from about 1.005 to about 1.010 (e.g., about 1.006, about 1.007, about 1.008, or about 1.009).

The pH of these hydrogel compositions is typically from about 8.0 to about 9.0 (e.g., from about 8.4 to about 9.0).

As detailed in the working Examples provided herein, hydrogel compositions of the present invention have been subjected to durability testing as described herein and have been observed to provide test results indicating the compositions are suitable for providing durable layers that may be adapted to a variety of application. For example, various compositions have been observed to form gels that can withstand in excess of 6000 mL of liquid when subjected to the drip testing as described herein.

### Xanthan Gum+Colloidal Silica

While the following discussion focuses on compositions containing xanthan gum, it is to be understood that various compositions containing one or more of these biopolymers may also be prepared in accordance with the present invention.

The formation of a water resistant hydrogel by the combination of xanthan gum and colloidal silica was surprising. For example, it was surprising to observe formation of a durable and/or water resistant hydrogel by combining xanthan gum and colloidal silica in the concentrations and relative proportions described herein.

It was also surprising to observe formation of a durable and/or water resistant hydrogel by combining micronized clay and colloidal silica in the concentrations and relative proportions described herein and in the absence of xanthan gum.

In accordance with the present invention, the hydrogels have been observed to be “water-like” when handling, dispensing, etc. This provides significant advantages in terms of ease of use, application, etc. Along with these properties, the hydrogels have been observed to exhibit durability that would not be expected from a “water-like” substance.

Durability testing data in accordance with the description above are reported herein in the Examples.

As detailed elsewhere herein, the hydrogels have a high water content, but nonetheless exhibit the advantageous durability while also exhibiting rheological properties believed to contribute to the similarity to water in terms of handling, application etc. In sum, therefore, in various aspects the hydrogels of the present invention are durable while also exhibiting “water-like” rheological properties, specifically viscosities and specific gravities specified herein.

The predominant component of the hydrogels of the present invention is water. The gels typically contain at least about 95 wt %, at least about 95.5 wt %, at least about 96 wt %, at least about 96.5 wt %, at least about 97 wt %, at least about 97.5 wt %, or at least about 98 wt %.

In various aspects, the present invention is directed to hydrogels formed from xanthan gum, colloidal silica, and water. It is currently believed the colloidal silica particles participate in xanthan cross-linking and, therefore, hydrogel formation.

Typically, xanthan gum is present in such hydrogels in in a proportion of at least about 0.05 wt %, at least about 0.1 wt %, at least about 0.15 wt %, or at least about 0.2 wt % of the composition. Generally, xanthan gum is present in these hydrogels in a proportion of from about 0.05 wt % to about 5 wt %, from about 0.1 wt % to about 4 wt %, from about 0.2 wt % to about 4 wt %, from about 0.2 wt % to about 3 wt %, from about 0.2 wt % to about 2 wt %, or from about 0.2 wt % to about 1 wt % of the composition. Suitable sources of xanthan gum include Kelco KELTROL, KELZAN, and XANVIS gums, Archer Daniels Midland (ADM) NOVAXAN 200 FG and OPTIXAN gums, and other commercially available sources.

Colloidal silica is present in such hydrogels in in a proportion of at least about 0.1 wt %, at least about 0.2 wt %, at least about 0.5 wt %, at least about 1 wt %, or at least about 1.5 wt % of the composition. Generally, colloidal silica is present in these hydrogels in a proportion of from about 0.1 wt % to about 5 wt %, from about 0.1 wt % to about 3 wt %, or from about 0.1 wt % to about 2 wt % of the composition (e.g., about 2.1 wt %).

Typically, the colloidal silica has a surface area of from about 125 m²/g to about 300 m²/g, or from about 130 m²/g to about 260 m²/g.

Suitable sources of colloidal silica include those commercially available from Grace, including LUDOX TM50, LUDOX TMA, LUDOX HSA, and LUDOX AM, and those commercially available from Nouryon, including LEVASIL CS30-425, CS40-614P, CS50-120, CS34-720, CS40-213, CS50-28, SP3088d, CC40) and other commercially available sources.

Generally, xanthan gum and colloidal silica are present in a proportion of from about 1:0.1 to about 1:0.5, or from about 1:1 to about 1:20. Typically, the hydrogel contains xanthan gum and colloidal silica at a weight ratio between 1:5 and 1:10. Typically, the balance of the hydrogel is water and one or more active agents.

The initial viscosity of xanthan gum and colloidal silica-containing hydrogels is typically at least about 100 centipoise (cP), at least about 150 cP, at least about 200 cP, at least about 300 cP, at least about 400 cP, at least about 500 cP, at least about 600 cP, at least about 700 cP, at least about 800 cP, or at least about 1000 cP.

In various embodiments, the viscosity of xanthan gum and colloidal silica-containing hydrogels after 24 hours of storage is at least about 100 centipoise (cP), at least about 150 cP, at least about 200 cP, at least about 300 cP, at least about 400 cP, at least about 500 cP, at least about 600 cP, at least about 700 cP, at least about 800 cP, or at least about 1000 cP.

In various embodiments wherein the proportion of xanthan gum and/or colloidal silica is at or near the higher end of the above-noted ranges the viscosity may be even higher than the above-noted limits. For example, wherein the proportion of xanthan gum and/or colloidal silica is at least about 1.0 wt %, at least about 1.5 wt %, or at least about 2.0 wt %, the initial viscosity and/or viscosity after 24 hours of storage may be greater than about 1200 cP, greater than about 1300 cP, greater than about 1400 cP, greater than about 1500 cP, greater than about 2000 cP, greater than about 3000 cP, greater than about 4000 cP, or even greater than about 5000 cP.

Typically, the specific gravity of the hydrogels is at least about 0.8, at least about 0.9, or at least about 1.0. In various embodiments, the specific gravity is from about 0.8 to about 1.2, from about 0.9 to about 1.1, or from about 0.95 to about 1.05.

Although the preceding discussion focuses on xanthan gum, other biopolymers may be suitable as well. These include, for example, guar gum, dextran, welan gum, gellan gum, diutan gum, pullulan, algin, collagen, casein, albumin, castor oil, cornstarch, arrowroot, yuca starch, carrageenan, konjac, alginate, gelatin, agar, pectin, cellulose gum, acacia guar gum, locust bean gum, acacia gum, gum tragacanth, glucomannan, alginic acid, sodium alginate, potassium alginate, ammonium alginate, calcium alginate, chitosan, carboxy methyl cellulose (CMC), methyl cellulose (MEC), hydroxyethyl cellulose (HEC), hydroxy methyl cellulose (HMC), hydroxypropyl methylcellulose (HPMC), ethylhydroxy methyl cellulose, and combinations thereof.

### Micronized Clay+Colloidal Silica

Various other embodiments of the present invention involve hydrogels containing and formed from the combination of colloidal silica and micronized clay. In such embodiments, the hydrogel is formed from the combination of micronized clay and colloidal silica in the absence of xanthan gum or any other polysaccharide or biopolymer. The formation of a hydrogel by these two components along with water was surprising.

The micronized clay is selected from the group consisting of attapulgite clay, kaolinite clay, halloysite clay, bentonite clay, sepiolite, and combinations thereof.

Generally, micronized clay is present in a proportion of at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt, about least about 2 wt %, at least about 2.1 wt %, at least about 2.2 wt %, at least about 2.3 wt %, at least about 2.4 wt, or at least about 2.5 wt % of the composition.

Micronized clay may be incorporated in proportions exceeding any of the above lower limits and below any of the following lower limits of less than about 7 wt %, less than about 6.5 wt %, less than about 6 wt %, less than about 6.5 wt %, less than about 6 wt %, less than about 5.5 wt %, less than about 5 wt %, less than about 4.9 wt %, less than about 4.8 wt %, less than about 4.7 wt %, less than about 4.6 wt %, less than about 4.5 wt %, less than about 4.4 wt %, less than about 4.3 wt %, less than about 4.2 wt %, less than about 4.1 wt %, less than about 4 wt %, less than about 3.9 wt %, less than about 3.8 wt %, less than about 3.7 wt %, less than about 3.6 wt %, less than about 3.5 wt %, less than about 3.4 wt %, less than about 3.3 wt %, less than about 3.2 wt %, less than about 3.1 wt %, less than about 3 wt %, less than about 2.9 wt %, less than about 2.8 wt %, less than about 2.7 wt %, less than about 2.6 wt %, or less than about 2.5 wt %.

In certain embodiments, micronized clay is present in a proportion of from about 1 wt % to about 3 wt %, or from about 1.5 wt % to about 2.5 wt %.

Colloidal silica is present in such hydrogels in in a proportion of at least about 0.1 wt %, at least about 0.2 wt %, at least about 0.5 wt %, at least about 1 wt %, or at least about 1.5 wt % of the composition. Generally, colloidal silica is present in these hydrogels in a proportion of from about 0.1 wt % to about 5 wt %, from about 0.1 wt % to about 3 wt %, or from about 0.1 wt % to about 2 wt % of the composition (e.g., about 2.1 wt %).

Typically, the colloidal silica has a surface area of from about 125 m²/g to about 300 m²/g, or from about 130 m²/g to about 260 m²/g.

Suitable sources of colloidal silica include those commercially available from Grace, including LUDOX TMA, LUDOX HAS, and LUDOX AM, those commercially available from Nouryon, including LEVASIL CS40-614P, LEVASIL CS30-425, and LEVASIL CS50-120, and other commercially available sources.

Generally, micronized clay and colloidal silica are present in a proportion of from about 1:0.1 to about 1:0.5, or from about 1:1 to about 1:20. Typically, the hydrogel contains micronized clay and colloidal silica at a weight ratio between 1:5 and 1:10. Typically, the balance of the hydrogel is water and one or more active agents.

The initial viscosity of micronized clay and colloidal silica-containing hydrogels is typically at least about 5 centipoise (cP), at least about 10 cP, at least about 15 cP, at least about 20 cP, at least about 25 cP, at least about 30 cP, at least about 40 cP, at least about 50 cP, at least about 60 cP, or at least about 70 cP.

In various embodiments, after 24 hours of storage the viscosity of micronized clay and colloidal silica-containing hydrogels is at least about 5 centipoise (cP), at least about 10 cP, at least about 15 cP, at least about 20 cP, at least about 25 cP, at least about 30 cP, at least about 40 cP, at least about 50 cP, at least about 60 cP, or at least about 70 cP.

Typically, the specific gravity of the hydrogels is at least about 0.8, at least about 0.9, or at least about 1.0. In various embodiments, the specific gravity is from about 0.8 to about 1.2, from about 0.9 to about 1.1, or from about 0.95 to about 1.05.

Having described the invention in detail, it will be apparent that modifications and variations are possible without departing from the scope of the invention defined in the appended claims.

### EXAMPLES

The following non-limiting examples are provided to further illustrate the present invention.

### Example 1

The following Example details formulations of the present invention and drip tests conducted on these formulations. The drip test was conducted as described herein. The information provided in this Example and elsewhere herein lists the concentrations of the components in the concentrated composition (“% Conc”) and after dilution (“% Dilute”) with water at the listed mix ratio (water:concentrate). For the Dilute concentration, the balance of the concentration up to 100% is water.

TABLE 1

| | Formulations and Data | | | |
|---|---|---|---|---|
| | A | | B | |
| Raw Materials | % Conc | % Dilute | % Conc | % Dilute |
| MAP | 22.35 | 4.69 | 22.37 | 4.69 |
| DAP | 25.20 | 5.28 | 25.22 | 5.29 |
| Water | 39.78 | 8.34 | 39.84 | 8.36 |
| Xanthan | 1.20 | 0.25 | 1.20 | 0.25 |
| Clay | 2.00 | 0.42 | 2.00 | 0.42 |
| Tolyltriazole | 0.17 | 0.04 | 0.17 | 0.04 |
| Sodium Molybdate | 0.10 | 0.02 | — | — |
| Colloidal Silica | 9.20 | 1.93 | 9.20 | 1.93 |
| Total | 100.00 | | 100.00 | |
| Mix Ratio (MR) | 5.1:1 | | 5.1:1 | |
| Viscosity (cP) spin#2 | | | | |
| Initial | 77 | 223 | 68 | 190 |
| 24 hr | 93 | 219 | 60 | 188 |
| Specific gravity (s.g.) | 1.353 | 1.060 | 1.353 | 1.056 |
| pH | 5.88 | 6.31 | 6.02 | 6.34 |

| | | |
|---|---|---|
| Drip Test (mL used) (avg) | 1800 | 1800 |

### Drip Test—Test Stopped at Volumes Given Due to Sample not Showing any Sign of Damage

### Example 2

The following Example details the effect of xanthan gum concentration on fire retardant formulations of the present invention.

TABLE 2

| | Formulations and Data | | | | | | | |
|---|---|---|---|---|---|---|---|---|
| | C | | D | | E | | F | |
| | % | % | % | % | % | % | % | % |
| Raw Materials | Conc | Dilute | Conc | Dilute | Conc | Dilute | Conc | Dilute |
| MAP | 22.26 | 4.66 | 22.51 | 4.71 | 22.42 | 4.69 | 22.31 | 4.67 |
| DAP | 25.11 | 5.26 | 25.38 | 5.31 | 25.29 | 5.29 | 25.17 | 5.27 |
| Water | 39.97 | 8.37 | 40.40 | 8.46 | 39.89 | 8.35 | 40.06 | 8.39 |
| Xanthan | — | — | 0.25 | 0.05 | 0.68 | 0.14 | 1.00 | 0.21 |
| Clay | 2.00 | 0.42 | 2.00 | 0.42 | 2.25 | 0.47 | 2.00 | 0.42 |
| Tolyltriazole | 0.16 | 0.03 | 0.16 | 0.03 | 0.17 | 0.04 | 0.16 | 0.03 |
| Sodium Molybdate | 0.10 | 0.02 | 0.10 | 0.02 | 0.10 | 0.02 | 0.10 | 0.02 |
| Colloidal Silica | 9.20 | 1.93 | 9.20 | 1.93 | 9.20 | 1.93 | 9.20 | 1.93 |
| Total | 98.80 | | 100.00 | | 100.00 | | 100.00 | |
| MR | 5.1:1 | | 5.1:2 | | 5.1:1 | | 5.1:1 | |
| Xanthan:Silica Ratio | — | | 1:36.8 | | 1:13.5 | | 1:9.2 | |
| Silica:Xanthan Ratio | — | | 1:0.03 | | 1:0.07 | | 1:0.11 | |
| Xanthan:Clay | — | | 1:8 | | 1:3 | | 1:2 | |
| Clay:Silica | 1:4.6 | | 1:4.6 | | 1:4.1 | | 1:4.6 | |
| Viscosity (cP) spin#2 | | | | | | | | |
| Initial | 49 | 5 | 74 | 19 | 148 | 86 | 66 | 112 |
| 24 hr | 42 | 6 | — | 20 | 185 | 85 | 48 | 116 |
| s.g. | 1.348 | 1.073 | 1.343 | 1.061 | 1.353 | 1.069 | 1.348 | 1.067 |
| pH | 5.88 | 6.32 | 6.13 | 6.39 | 6.14 | 6.33 | 5.91 | 6.31 |
| Drip Test (mL used) | 30 | | 11 | | 1033 | | 3332 | |
| (avg) | | | | | | | | |

TABLE 3

| | Formulations and Data | | | |
|---|---|---|---|---|
| | G | | H | |
| | % | % | % | % |
| Raw Materials | Conc | Dilute | Conc | Dilute |
| MAP | 22.35 | 4.69 | 22.37 | 4.69 |
| DAP | 25.20 | 5.28 | 25.22 | 5.29 |
| Water | 39.78 | 8.34 | 39.84 | 8.36 |
| Xanthan | 1.20 | 0.26 | 1.20 | 0.26 |
| Clay | 2.00 | 0.43 | 2.00 | 0.43 |
| Tolytriazole | 0.17 | 0.04 | 0.17 | 0.04 |
| Sodium Molybdate | 0.10 | 0.02 | — | — |
| Colloidal Silica | 9.20 | 1.96 | 9.20 | 1.96 |
| Total | 100.00 | | 100.00 | |
| MR | 5.1:1 | | 5.1:1 | |
| Xanthan:Silica Ratio | 1:7.7 | | 1:7.7 | |
| Silica:Xanthan Ratio | 1:0.13 | | 1:0.13 | |
| Xanthan:Clay | 1:1.7 | | 1:1.7 | |
| Clay:Silica | 1:46 | | 1:46 | |
| Viscosity (cP) spin#2 | | | | |
| Initial | 77 | 205 | 68 | 190 |
| 24 hr | 77 | 228 | 60 | 188 |
| s.g. | 1.353 | 1.060 | 1.353 | 1.056 |
| pH | 5.88 | 6.31 | 6.02 | 6.34 |

| | | |
|---|---|---|
| Drip Test (mL used)(avg) | 1800 | 1800 |

TABLE 4

Formulations and Data
I

| | % | % |
|---|---|---|
| Raw Materials | Conc | Dilute |
| MAP | 22.25 | 4.68 |
| DAP | 25.09 | 5.28 |
| Water | 39.59 | 8.33 |
| Xanthan | 1.35 | 0.28 |
| Clay | 2.25 | 0.47 |
| Tolyltriazole | 0.17 | 0.04 |
| Sodium Molybdate | 0.10 | 0.02 |
| Colloidal Silica | 9.20 | 1.93 |
| Total | 100.00 | |

| | |
|---|---|
| MR | 5.1:1 |
| Xanthan:Silica Ratio | 1:6.8 |
| Silica:Xanthan Ratio | 1:0.15 |
| Xanthan:Clay | 1:1.7 |
| Clay:Silica | 1:4.1 |

| | | |
|---|---|---|
| Viscosity (cP) spin#2 | | |
| Initial | 203 | 246 |
| 24 hr | 223 | 281 |
| s.g. | 1.354 | 1.064 |
| pH | 6.07 | 6.34 |

| | |
|---|---|
| Drip Test (mL used)(avg) | 1800 |

TABLE 5

Formulations and Data
J

| | % | % |
|---|---|---|
| Raw Materials | Conc | Dilute |
| MAP | 21.13 | 4.72 |
| DAP | 23.82 | 5.32 |
| Water | 37.60 | 8.39 |
| Xanthan | 6.70 | 1.50 |
| Clay | 2.00 | 0.45 |
| Tolyltriazole | 0.15 | 0.03 |
| Sodium Molybdate | 0.10 | 0.02 |
| Colloidal Silica | 8.50 | 1.90 |
| Total | 100.00 | |

| | |
|---|---|
| MR | 4.7:1 |
| Xanthan:Silica Ratio | 1:1.3 |
| Silica:Xanthan Ratio | 1:0.80 |
| Xanthan:Clay | 1:0.30 |
| Clay:Silica | 1:4.25 |

| | | |
|---|---|---|
| Viscosity (cP) spin#2 | | |
| Initial | 276 | 4683* |
| 24 hr | — | 4280 |
| s.g. | 1.482 | 1.028 |
| pH | 5.88 | 6.46 |

| | |
|---|---|
| Drip Test (mL used) (avg) | 2000 |

*Viscosity measured with a #4 spindle.

### Example 3

The following Example details the effect of clay concentration on fire retardant formulations of the present invention.

TABLE 6

| | Formulations and Data | | | | | |
|---|---|---|---|---|---|---|
| | K | | L | | M | |
| | % | % | % | % | % | % |
| Raw Materials | Conc | Dilute | Conc | Dilute | Conc | Dilute |
| MAP | 22.26 | 4.66 | 22.51 | 4.71 | 22.39 | 4.69 |
| DAP | 25.11 | 5.26 | 25.40 | 5.32 | 25.25 | 5.29 |
| Water | 39.97 | 87.43 | 40.43 | 8.46 | 40.20 | 8.41 |
| Xanthan | 1.20 | 0.25 | 1.20 | 0.25 | 1.20 | 0.25 |
| Clay | — | — | 1.00 | 0.21 | 1.50 | 0.31 |
| Tolyltriazole | 0.16 | 0.03 | 0.16 | 0.03 | 0.16 | 0.03 |
| Sodium Molybdate | 0.10 | 0.02 | 0.10 | 0.02 | 0.10 | 0.02 |
| Colloidal Silica | 9.20 | 1.93 | 9.20 | 1.93 | 9.20 | 1.93 |
| Total | 98.00 | | 100.00 | | 100.00 | |
| MR | 5.1:1 | | 5.1:1 | | 5.1:2 | |
| Xanthan:Silica Ratio | 1:7.7 | | | | | |
| Silica:Xanthan Ratio | 1:0.13 | | | | | |
| Xanthan:Clay | — | | 1:0.8 | | 1:1.3 | |
| Clay:Silica | — | | 1:9.2 | | 1:6.1 | |
| Viscosity (cP) spin#2 | | | | | | |
| Initial | 28 | 150 | 38 | 137 | 32 | 165 |
| 24 hr | 25 | 153 | 26 | 150 | 38 | 172 |
| s.g. | 1.337 | 1.027 | 1.346 | 1.067 | 1.348 | 1.066 |
| pH | 5.94 | 6.33 | 5.89 | 6.31 | 5.89 | 6.3 |

| | | | |
|---|---|---|---|
| Drip Test (mL used)(avg) | 5647 | 785 | 2316 |

TABLE 7

| | Formulations and Data | | | |
|---|---|---|---|---|
| | N | | O | |
| | % | % | % | % |
| Raw Materials | Conc | Dilute | Conc | Dilute |
| MAP | 22.36 | 4.68 | 22.35 | 4.69 |
| DAP | 25.21 | 5.28 | 25.20 | 5.28 |
| Water | 39.77 | 8.32 | 39.78 | 8.34 |
| Xanthan | 1.20 | 0.25 | 1.20 | 0.26 |
| Clay | 2.00 | 0.42 | 2.00 | 0.43 |
| Tolyltriazole | 0.16 | 0.03 | 0.17 | 0.04 |
| Sodium Molybdate | 0.10 | 0.02 | 0.10 | 0.02 |
| Colloidal Silica | 9.20 | 1.93 | 9.20 | 1.96 |
| Total | 100.00 | | 100.00 | |
| MR | 5.1:1 | | 5.1:1 | |
| Xanthan:Silica Ratio | 1:7.7 | | | |
| Silica:Xanthan Ratio | 1:0.13 | | | |
| Xanthan:Clay | 1:1.7 | | 1:1.7 | |
| Clay:Silica | 1:4.6 | | 1:4.6 | |
| Viscosity (cP) spin#2 | | | | |
| Initial | 152 | 178 | 77 | 205 |
| 24 hr | 114 | 194 | 77 | 228 |
| s.g. | 1.349 | 1.064 | 1.353 | 1.060 |
| pH | 5.9 | 6.35 | 5.88 | 6.31 |

| | | |
|---|---|---|
| *Days after sample was made | 5 | 6 |
| Drip Test (mL used)(avg) | 1800 | 1800 |

### Example 4

The following Example details the effect of colloidal silica concentration on fire retardant formulations of the present invention.

TABLE 8

Formulations and Data
P

| | % | % |
|---|---|---|
| Raw Materials | Conc | Dilute |
| MAP | 24.58 | 4.71 |
| DAP | 27.71 | 5.31 |
| Water | 43.72 | 8.37 |
| Xanthan | 1.23 | 0.24 |
| Clay | 2.00 | 0.38 |
| Tolyltriazole | 0.16 | 0.03 |
| Sodium Molybdate | 0.10 | 0.02 |
| Colloidal Silica | 0.50 | 0.10 |
| Total | 100.00 | |

| | |
|---|---|
| MR | 5.7:1 |
| Xanthan:Silica Ratio | 1:0.4 |
| Silica:Xanthan Ratio | 1:2.5 |
| Xanthan:Clay | 1:1.6 |
| Clay:Silica | 1:0.25 |
| Drip Test (mL used)(avg) | 484 |
| *Days after sample was made | — |

| | | |
|---|---|---|
| Viscosity (cP) spin#2 | | |
| Initial | 96 | 103 |
| 24 hr | — | 131 |
| s.g. | 1.324 | 1.060 |
| pH | 5.76 | 6.34 |

TABLE 9

| | Formulations and Data | | | |
|---|---|---|---|---|
| | Q | | R | |
| Raw Materials | % Conc | % Dilute | % Conc | % Dilute |
| MAP | 24.04 | 4.67 | 23.40 | 4.68 |
| DAP | 27.10 | 5.26 | 26.38 | 5.28 |
| Water | 42.77 | 8.19 | 41.63 | 8.33 |
| Xanthan | 1.23 | 0.24 | 1.23 | 0.25 |
| Clay | 2.00 | 0.38 | 2.10 | 0.42 |
| Tolyltriazole | 0.16 | 0.03 | 0.16 | 0.03 |
| Sodium Molybdate | 0.10 | 0.02 | 0.10 | 0.02 |
| Colloidal Silica | 2.60 | 0.50 | 5.00 | 1.00 |
| Total | 100.00 | | 100.00 | |
| MR | 5.6:1 | | 5.4:1 | |
| Xanthan:Silica Ratio | 1:2.1 | | 1:4.1 | |
| Silica:Xanthan Ratio | 1:0.47 | | 1:0.25 | |
| Xanthan:Clay | 1:1.6 | | 1:1.7 | |
| Clay:Silica | 1:1.3 | | 1:2.4 | |
| Drip Test (mL used)(avg) | | | 310 | |
| Viscosity (cP) spin#2 | | | | |
| Initial | 103 | 114 | 101 | 168 |
| 24 hr | — | 134 | 86 | 162 |
| s.g. | 1.331 | 1.061 | 1.338 | 1.022 |
| pH | 5.81 | 6.39 | 5.79 | 6.30 |

TABLE 10

| | Formulations and Data | | | |
|---|---|---|---|---|
| | S | | T | |
| Raw Materials | % Conc | % Dilute | % Conc | % Dilute |
| MAP | 23.12 | 4.69 | 22.83 | 4.71 |
| DAP | 26.07 | 5.29 | 25.74 | 5.31 |
| Water | 41.14 | 8.35 | 40.61 | 8.37 |
| Xanthan | 1.21 | 0.25 | 1.21 | 0.25 |
| Clay | 2.05 | 0.42 | 2.05 | 0.42 |
| Tolyltriazole | 0.16 | 0.03 | 0.16 | 0.03 |
| Sodium Molybdate | 0.10 | 0.02 | 0.10 | 0.02 |
| Colloidal Silica | 6.15 | 1.25 | 7.30 | 1.50 |
| Total | 100.00 | | 100.00 | |
| MR | 5.3:1 | | 5.2:1 | |
| Xanthan:Silica Ratio | 1:5.1 | | 1:6 | |
| Silica:Xanthan Ratio | 1:0.2 | | 1:0.17 | |
| Xanthan:Clay | 1:1.7 | | 1:1.7 | |
| Clay:Silica | 1:3 | | 1:3.6 | |
| Drip Test (mL used)(avg) | 1541 | | 841 | |
| Viscosity (cP) spin#2 | | | | |
| Initial | 105 | 171 | 110 | 170 |
| 24 hr | 79 | 167 | 80 | 164 |
| s.g. (g/ml) | 1.338 | 1.025 | 1.328 | 1.014 |
| pH | 5.82 | 6.32 | 5.80 | 6.33 |

TABLE 11

| | Formulations and Data | | | |
|---|---|---|---|---|
| | U | | V | |
| Raw Materials | % Conc | % Dilute | % Conc | % Dilute |
| MAP | 22.57 | 4.72 | 22.36 | 4.68 |
| DAP | 25.45 | 5.33 | 25.21 | 5.28 |
| Water | 40.16 | 8.41 | 39.77 | 8.32 |
| Xanthan | 1.21 | 0.25 | 1.20 | 0.25 |
| Clay | 2.00 | 0.42 | 2.00 | 0.42 |
| Tolyltriazole | 0.16 | 0.03 | 0.16 | 0.03 |
| Sodium Molybdate | 0.10 | 0.02 | 0.10 | 0.02 |
| Colloidal Silica | 8.35 | 1.75 | 9.20 | 1.93 |
| Total | 100.00 | | 100.00 | |
| MR | 5.1:1 | | 5.1:1 | |
| Xanthan:Silica Ratio | 1:6.9 | | 1:7.7 | |
| Silica:Xanthan Ratio | 1:0.15 | | 1:0.13 | |
| Xanthan:Clay | 1:1.6 | | 1:1.7 | |
| Clay:Silica | 1:4.2 | | 1:4.6 | |
| Drip Test (mL used)(avg) | 891 | | 1800 | |
| Viscosity (cP) spin#2 | | | | |
| Initial | 101 | 179 | 152 | 178 |
| 24 hr | 67 | 167 | 114 | 194 |
| s.g. | 1.329 | 1.023 | 1.349 | 1.064 |
| pH | 5.79 | 6.3 | 5.90 | 6.35 |

### Example 5

The following example details results testing varying the xanthan gum to silica ratio.

TABLE 12

| | Formulations and Data | | |
|---|---|---|---|
| | 1 | 2 | 3 |
| Raw Materials | % Dil | % Dil | % Dil |
| Water | 87.43 | 87.43 | 97.57 |
| Xanthan | 0.25 | 0.25 | 0.28 |
| Clay | 0.42 | — | — |
| Colloidal Silica | 1.93 | — | 0.03 |
| Total | 90.03 | 87.68 | 97.88 |
| Xanthan:Silica Ratio | 1:7.7 | | 1:0.1 |
| Silica:Xanthan Ratio | 1:0.13 | | 1:9 |
| Viscosity (cP) spin#2 | | | |
| Initial | 192 | 200 | 193 |
| 24 hr | 180 | 188 | 178 |
| s.g. | 1.004 | 0.995 | 0.998 |
| pH | 9.11 | 7.68 | 7.96 |
| Drip Test | 6000 | 85 | 2707 |
| (mL used)(avg) | | | |

TABLE 13

Formulations and Data

| | 4 | 5 | 6 |
|---|---|---|---|
| Raw Materials | % Dil | % Dil | % Dil |
| Water | 97.57 | 97.57 | 97.57 |
| Xanthan | 0.28 | 0.25 | 1.08 |
| Clay | — | — | — |
| Colloidal Silica | 0.14 | 0.25 | 2.15 |
| Total | 97.99 | 98.07 | 100.80 |
| Xanthan:Silica Ratio | 1:0.5 | 1:1 | 1:2 |
| Silica:Xanthan Ratio | 1:0.2 | 1:1 | 1:0.5 |
| Viscosity (cP) spin#2 | | | |
| Initial | 190 | 166 | 1450* |
| 24 hr | 175 | 158 | 1400* |
| s.g. | 0.999 | 0.994 | Too many |
| | | | air bubbles |
| | | | to record |
| pH | 7.89 | 7.69 | 7.47 |
| Drip Test | 6450 | 6000 | 6000 |
| (mL used) (avg) | | | |

*Viscosity measured with a #4 spindle

TABLE 14

| | Formulations and Data | | | |
|---|---|---|---|---|
| | 7 | 8 | 9 | 10 |
| Raw Materials | % Dil | % Dil | % Dil | % Dil |
| Water | 97.57 | 87.43 | 97.57 | 97.57 |
| Xanthan | 0.28 | 0.25 | 0.28 | 0.11 |
| Clay | — | — | — | — |
| Colloidal Silica | 1.40 | 1.93 | 2.80 | 2.15 |
| Total | 99.25 | 89.61 | 100.65 | 99.83 |
| Xanthan:Silica Ratio | 1:5 | 1:7.7 | 1:10 | 1:20 |
| Silica:Xanthan Ratio | 1:0.1 | 1:0.13 | 1:0.2 | 1:0.05 |
| Viscosity (cP) spin#2 | | | | |
| Initial | 194 | 187 | 188 | 48 |
| 24 hr | 178 | 175 | 175 | 43 |
| s.g. | 0.998 | 0.989 | 1.004 | 1.004 |
| pH | 8.60 | 8.87 | 8.91 | 8.84 |
| Drip Test | 6000 | 6000 | 6000 | 6000 |
| (mL used)(avg) | | | | |

### Example 6

The following example details results testing varying the amounts of clay.

TABLE 15

| | Formulations and Data | | | |
|---|---|---|---|---|
| | 11 | 12 | 13 | 14 |
| Raw Materials | % Dil | % Dil | % Dil | % Dil |
| Water | 87.43 | 97.84 | 97.80 | 97.35 |
| Clay | 0.42 | 0.01 | 0.05 | 0.50 |
| Colloidal Silica | 1.93 | 2.15 | 2.15 | 2.15 |
| Total | 89.78 | 100.00 | 100.00 | 100.00 |
| Viscosity (cP) spin#2 | | | | |
| Initial | 6 | 5 | 5 | 6 |
| 24 hr | 8 | 5 | 5 | 5 |
| s.g. | 1.005 | 1.004 | 1.005 | 1.006 |
| pH | 8.94 | 8.85 | 8.72 | 9.08 |
| *Sample made | 1 | 2 | 1 | 2 |
| Drip Test | 6000 | 2554 | 6000 | 6000 |
| (mL used)(avg) | | | | |

TABLE 16

| | Formulations and Data | | | |
|---|---|---|---|---|
| | 15 | 16 | 17 | 18 |
| Raw Materials | % Dil | % Dil | % Dil | % Dil |
| Water | 96.85 | 95.85 | 94.85 | 92.85 |
| Clay | 1.00 | 2.00 | 3.00 | 5.00 |
| Colloidal Silica | 2.15 | 2.15 | 2.15 | 2.15 |
| Total | 100.00 | 100.00 | 100.00 | 100.00 |
| Viscosity (cP) spin#2 | | | | |
| Initial | 8 | 14 | 15 | 19 |
| 24 hr | 5 | 5 | 5 | 8 |
| s.g. | 1.010 | 1.019 | 1.022 | 1.034 |
| pH | 9.36 | 9.63 | 9.79 | 10.04 |
| *Sample made | 2 | 2 | 5 | 1 |
| Drip Test | 6000 | 6000 | 6000 | 6000 |
| (mL used) (avg) | | | | |

### Example 7

The following Example details formulations of different xanthan gum:colloidal silica weight ratio.

TABLE 17

| | Formulations and Data | | | |
|---|---|---|---|---|
| | 19 | 20 | 21 | 22 |
| Raw Materials | % Dil | % Dil | % Dil | % Dil |
| Water | 97.8 | 97.77 | 97.75 | 97.35 |
| Xanthan | 0.05 | 0.075 | 0.1 | 0.5 |
| Colloidal Silica | 2.15 | 2.15 | 2.15 | 2.15 |
| Total | 100.00 | 100.00 | 100.00 | 100.00 |
| Viscosity (cP) spin#2 | | | | |
| Initial | 17 | 33 | 47 | 414 |
| 24 hr | 17 | 26 | 40 | 403 |
| s.g. | 1.004 | 1.004 | 1.005 | 1.001 |
| pH | 8.82 | 8.76 | 8.90 | 8.67 |
| Drip Test | | 6000 | 6000 | 6000 |
| (mL used) (avg) | | | | |

TABLE 18

| | Formulations and Data | | | |
|---|---|---|---|---|
| | 23 | 24 | 25 | 26 |
| Raw Materials | % Dil | % Dil | % Dil | % Dil |
| Water | 96.85 | 95.85 | 94.85 | 92.85 |
| Xanthan | 1.00 | 2.00 | 3.00 | 5.00 |
| Colloidal Silica | 2.15 | 2.15 | 2.15 | 2.15 |
| Total | 100.00 | 100.00 | 100.00 | 100.00 |
| Viscosity (cP) spin#2 | | | | |
| Initial | 1467 | 2433 | 4133 | 8766 |
| 24 hr | 1267 | 2333 | 4333 | 9767 |
| s.g. | 0.983 | 1.005 | 0.974 | 1.008 |
| pH | 8.40 | 7.62 | 7.45 | 7.00 |
| Drip Test | | 6000 | 6000 | 6000 |
| (mL used) (avg) | | | | |

### Example 8

The following example describes compositions prepared in accordance with the following and providing the viscosity, refractive index, specific gravity, pH and drip test results as reported by below.

Formulation of all samples, w/ different thickeners

| Raw Materials | % Dil |
|---|---|
| Water | 97.57 |
| Thickener | 0.28 |
| Colloidal Silica | 2.15 |
| Total | 100.00 |
| Ratio (Thickener:Silica) | 0.13 |

| Formulation | 8-A | 8-B | 8-C | 8-D |
|---|---|---|---|---|
| Thickener | Sodium | Guar gum | Sodium | Gum arabic |
| | alginate | | carboxymethyl | |
| | | | cellulose | |
| Characterization | | | | |
| Viscosity (cP) | 24 | 42 | 64 | 4 |
| [spin#2] | | | | |
| [10-min] | | | | |
| Viscosity (cP) | 27 | 45 | 58 | 5 |
| [spin#2] | | | | |
| R.I (10440) | 0.7 | 0.6 | 0.7 | 0.7 |
| Specific | 1.007 | 1.006 | 1.007 | 1.006 |
| gravity (s.g.) | | | | |
| pH | 8.97 | 8.66 | 8.94 | 8.70 |
| Drip Test | >6000 | >6000 | >6000 | 1200 |
| (mL)(avg) | | | | |

| Formulation | 8-E | 8-F | 8-G | 8-H |
|---|---|---|---|---|
| Thickener | Albumin | Calcium | Casein | (Hydroxypropyl) |
| | | alginate | sodium | methyl |
| | | | salt | cellulose |
| Characterization | | | | |
| Viscosity (cP) | 66 | 6 | 102 | 117 |
| [spin#2] | | | | |
| [10-min] | | | | |
| Viscosity (cP) | 3 (1 wk) | 3 (1 wk) | 3 (1 wk) | 15 (1 wk) |
| [spin#2] | | | | |
| R.I (10440) | 0.6 | 0.3 | 0.7 | 0.6 |
| s.g. | 1.006 | 1.006 | 1.006 | 1.006 |
| pH | 8.47 | 8.64 | 8.41 | 8.75 |
| Drip Test | >6000 | >6000 | >6000 | >6000 |
| (mL) (avg) | | | | |

| Formulation | 8-I | 8-J | 8-K | 8-L |
|---|---|---|---|---|
| Thickener | Locust bean | Pectin | Cetearyl | Corn starch |
| | gum | | alcohol | |
| Characterization | — | — | — | — |
| Viscosity (cP) | 10 | 8 | — | 3 |
| [spin#2] | | | | |
| [10-min] | | | | |
| Viscosity (cP) | 3 (1 wk) | 5 (1 wk) | — | 3 |
| [spin#2] | | | | |
| R.I (10440) | 0.5 | 0.6 | — | 0.3 |
| s.g. | 1.006 | 1.007 | — | 1.006 |
| pH | 8.69 | 8.68 | — | 8.67 |
| Drip Test (mL) (avg) | >6000 | >6000 | N/A | >6000 |

| Formulation | 8-M | 8-N | 8-0 | 8-P |
|---|---|---|---|---|
| Thickener | Polyethylene | Welan gum | Cetyl | Arrowroot |
| | glycol | | alcohol | starch |
| Characterization | — | — | — | — |
| Viscosity (cP) | 3 | 252 | — | 3 |
| [spin#2] | | | | |
| [10-min] | | | | |
| Viscosity (cP) | 3 | 168 (2 wk) | — | 3 |
| [spin#2] | | | | |
| R.I (10440) | 0.6 | 0.6 | — | 0.3 |
| s.g. | 1.006 | 0.984 | — | 1.010 |
| pH | 8.88 | 8.65 | — | 8.67 |
| Drip Test (mL) (avg) | 80 | >6000 | N/A | >6000 |

| Formulation | 8-Q | 8-R | 8-S | 8-T |
|---|---|---|---|---|
| Thickener | Alginic acid | Chitosan | Dextran | Gelatin |
| Characterization | — | — | — | — |
| Viscosity (cP) [spin#2] | 5 | 15 | 2 | 4 |
| [10-min] | | | | |
| Viscosity (cP) [spin#2] | 12 | 18 | 8 | 9 |
| R.I (10440) | 0.4 | 0.4 | 0.7 | 0.4 |
| s.g. | 1.007 | 1.007 | 1.006 | 1.005 |
| pH | 3.45 | 8.49 | 8.46 | 8.27 |
| Drip Test (mL) (avg) | >6000 | >6000 | >6000 | >6000 |

| Formulation | 8-U | 8-V | 8-W | 8-X |
|---|---|---|---|---|
| Thickener | Pullulan | Methyl | Hydroxyethyl | Tragacanth |
| | | cellulose | cellulose | gum |
| Characterization | | | | |
| Viscosity (cP) | 8 | 13 | 130 | 16 |
| [spin#2] | | | | |
| [10-min] | | | | |
| Viscosity (cP) | 8 | 15 | 126 | 19 |
| [spin#2] | | | | |
| R.I (Brix), | 0.7 | 0.6 | 0.4 | 0.6 |
| (10440) | | | | |
| s.g. | 1.006 | 1.006 | 1.006 | 1.006 |
| pH | 8.48 | 8.71 | 8.64 | 8.50 |
| Drip Test | >6000 | >6000 | >6000 | >6000 |
| (mL) (avg) | | | | |

| Formulation | 8-Y | 8-Z | 8-AA | 8-AB |
|---|---|---|---|---|
| Thickener | Castor oil | Agar agar | Diutan | Gellan gum |
| | | | gum | (low acyl) |
| Characterization | | | | |
| Viscosity (cP) | 8 | 8 | 396 | 8 |
| [spin#2] | | | | |
| [10-min] | | | | |
| Viscosity (cP) | 11 | 8 | 407 | 20 |
| [spin#2] | | | | |
| R.I (10440) | 0.3 | 0.5 | 0.7 | 0.6 |
| s.g. | 1.005 | 1.005 | 1.006 | 1.006 |
| pH | 8.97 | 8.68 | 8.65 | 8.72 |
| Drip Test | 120 | >6000 | — | 160 |
| (mL) (avg) | | | | |

| Formulation | 8-AC | 8-AD | 8-AE | 8-AF |
|---|---|---|---|---|
| Thickener | Gellan gum | Konjac | Carrageenan | Yuca starch |
| | (high acyl) | | | |
| Characterization | | | | |
| Viscosity (cP) | 16 | 158 | 29 | 10 |
| [spin#2] | | | | |
| [10-min] | | | | |
| Viscosity (cP) | 14 | 241 | 30 | 8 |
| [spin#2] | | | | |
| R.I(10440) | 0.6 | 0.7 | 0.7 | 0.3 |
| s.g. | 1.006 | 1.006 | 1.006 | 1.006 |
| pH | 8.66 | 8.60 | 9.08 | 8.52 |
| Drip Test | >6000 | >6000 | >6000 | >6000 |
| (mL) (avg) | | | | |

### Example 9

The following example provides shear testing results for the composition described in Example 8 (0.28 wt % thickener).

| | Avg Low | High | Low Shear |
|---|---|---|---|
| Sample | shear t1 (cP) | shear (cP) | t3 (cP) |
| 8-Q | 13234.756 | 9.9 | 709.37 |
| 8-R | 209380.326 | 6.28 | 115047.76 |
| 8-Z | 1336123.244 | 12.21 | 364244.63 |
| 8-AA * | 16736.34 | 4.84 | 14518.95 |
| 8-AB | 75712.328 | 4.1 | 10861.36 |
| 8-AC | 200472.676 | 10.09 | 18637.78 |
| 8-AD * | 410.968 | 8.21 | 375.63 |

*TI < 1 (shear-thickening behavior)

| | | Thixotropic Index | |
|---|---|---|---|
| | | (Avg. Low | Drip test |
| | % Recovery of | Shear/High | Avg. |
| Sample (0.28%) | Viscosity | Shear) | (mL) |
| 8-Q Alginic acid | 5.36 | 1337 | >6000 |
| 8-R Chitosan | 54.95 | 33341 | >6000 |
| 8-Z Agar agar | 27.26 | 109429 | >6000 |
| 8-AA Diutan gum | 86.75 | 3458 | n/a |
| 8-AB Gellan gum | 14.35 | 18466 | 160 |
| (low acyl) | | | |
| 8-AC Gellan gum | 9.30 | 19868 | >6000 |
| (high acyl) | | | |
| 8-AD Konjac | 91.40 | 50 | >6000 |

### Example 10

The following example describes compositions prepared in accordance with the following and providing the viscosity, refractive index, specific gravity, pH and drip test results as reported by below.

Formulation of all samples, w/ different thickeners

| Raw Materials | % Dil |
|---|---|
| Water | 97.80 |
| Thickener | 0.05 |
| Colloidal Silica | 2.15 |
| Total | 100.00 |
| Ratio (Thickener:Silica) | 0.02 |

| Formulation | 10-E1 | 10-G1 | 10-I1 | 10-N1 |
|---|---|---|---|---|
| Thickener | Albumin | Casein sodium | Locust | Welan |
| | | salt | bean gum | gum |
| Characterization | | | | |
| Viscosity (cP) | 24 | 12 | 9 | 15 |
| [spin#2] | | | | |
| [10-min] | | | | |
| Viscosity (cP) | 7 | 6 | 10 | 15 |
| [spin#2] | | | | |
| R.I (10440) | 0.5 | 0.5 | 0.5 | 0.5 |
| s.g. | 1.005 | 1.005 | 1.005 | 1.005 |
| pH | 8.44 | 8.53 | 8.54 | 8.62 |
| Drip Test (mL) | 90 | >6000 | >6000 | >6000 |

| Formulation | 10-L1 | 10-Q1 | 10-T1 | 10-X1 |
|---|---|---|---|---|
| Thickener | Corn | Alginic | Gelatin | Tragacanth |
| Characterization | starch | acid | | gum |
| Viscosity (cP) | 4 | 4 | 6 | 8 |
| [spin#2] | | | | |
| [10-min] | | | | |
| Viscosity (cP) | 8 | 9 | 6 | 8 |
| [spin#2] | | | | |
| R.I (10440) | 0.4 | 0.4 | 0.4 | 0.4 |
| s.g. | 1.005 | 1.005 | 1.005 | 1.005 |
| pH | 8.52 | 8.76 | 8.53 | 8.53 |
| Drip Test (mL) | 120 | >6000 | >6000 | >6000 |

| Formulation | 10-M1 | 10-Y1 | 10-Z1 | 10-D1 |
|---|---|---|---|---|
| Thickener | Polyethylene | Castor oil | Agar agar | Konjac |
| | glycol | | | |
| Characterization | | | | |
| Viscosity (cP) | 11 | 12 | 10 | 16 |
| [spin#2] | | | | |
| [10-min] | | | | |
| Viscosity (cP) | 11 | 15 | 12 | 15 |
| [spin#2] | | | | |
| R.I (10440) | 0.5 | 0.5 | 0.5 | 0.5 |
| s.g. | 1.006 | 1.005 | 1.005 | 1.005 |
| pH | 8.89 | 8.94 | 8.78 | 8.79 |
| Drip Test (mL) | >6000 | >6000 | >6000 | >6000 |

| Formulation | 10-B1 | 10-C1 | 10-D1 | 10-W1 |
|---|---|---|---|---|
| Thickener | Guar | Carboxy- | Gum | Hydroxyethyl |
| | | methyl | arabic | cellulose |
| | | cellulose | | |
| Characterization | | | | |
| Viscosity (cP) | 13 | 13 | 9 | 19 |
| [spin#2] | | | | |
| [10-min] | | | | |
| Viscosity (cP) | 10 | 9 | 5 | 7 |
| [spin#2] | | | | |
| R.I (10440) | 0.5 | 0.5 | 0.5 | 0.1 |
| s.g. | 1.005 | 1.005 | 1.005 | 1.009 |
| pH | 8.72 | 8.89 | 8.71 | 8.67 |
| Drip Test (mL) | >6000 | >6000 | >6000 | >6000 |

| Formulation | 10-J1 | 10-R1 | 10-U1 | 10-V1 |
|---|---|---|---|---|
| Thickener | Pectin | Chitosan | Pullulan | Methyl |
| | | | | cellulose |
| Characterization | | | | |
| Viscosity (cP) | 8 | 8 | 5 | 23 |
| [spin#2] | | | | |
| [10-min] | | | | |
| Viscosity (cP) | 7 | 8 | 8 | 8 |
| [spin#2] | | | | |
| R.I (10440) | 0.5 | 0.5 | 0.5 | 0.5 |
| s.g. | 1.005 | 1.006 | 1.005 | 1.005 |
| pH | 8.64 | 8.62 | 8.67 | 8.64 |
| Drip Test (mL) | >6000 | 150 | >6000 | >6000 |

| Formulation | 10-AA1 | 10-H1 | 10-S1 | 10-AC1 | 10-AE1 |
|---|---|---|---|---|---|
| Thickener | Diutan | Hydroxypropyl | Dextran | Gellan Gum | Carrageenan |
| | | methylcellulose | | | |
| Characterization | | | | | |
| Viscosity (cP) | 37 | 13 | 8 | 7 | 10 |
| [spin#2] | | | | | |
| [10-min] | | | | | |
| Viscosity (cP) | 50 | 8 | 5 | 5 | 11 |
| [spin#2] | | | | | |
| R.I (10440) | 0.5 | 0.5 | 0.5 | 0.5 | 0.5 |
| s.g. | 1.005 | 1.005 | 1.005 | 1.005 | 1.005 |
| pH | 8.69 | 8.65 | 8.66 | 8.74 | 8.85 |
| Drip Test (mL) | >6000 | >6000 | >6000 | >6000 | >6000 |

### Example 11

The following example provides shear testing results for the composition described in Example 10 (0.05 wt % thickener).

| Sample | Avg Low shear t1 (cP) | High shear (cP) | Low Shear t3 (cP) |
|---|---|---|---|
| 10-I1 | 13147.40 | 1.41 | 8694.65 |
| 10-Q1 | 38235.43 | 1.32 | 6601.80 |
| 10-T1 | 717543.46 | 5.5 | 405530.62 |
| 10-Z1 | 451602.14 | 5.97 | 178440.18 |
| 10-W1 | 43066.48 | 1.54 | 40523.09 |
| 10-AA1 | 500.87 | 2.02 | 477.97 |
| 10-V1 | 3350.32 | 1.41 | 2734.66 |
| 10-AC1 | 5647.40 | 1.28 | 939 |
| 10-H1 | 1094.44 | 1.03 | 1056.60 |

*TI < 1 (shear-thickening behavior)

| | | Thixotropic Index | |
|---|---|---|---|
| | | (Avg. Low | Driptest |
| | % Recovery of | Shear/High | Avg. |
| Sample (0.05%) | Viscosity | Shear) | (mL) |
| 10-I1 Locust bean gum | 66.13 | 9324 | >6000 |
| 10-Q1 Algenic acid | 17.27 | 28966 | >6000 |
| 10-T1 Gelatin | 56.52 | 130462 | >6000 |
| 10-Z1 Agar agar | 39.51 | 75645 | >6000 |
| 10-W1 HEC | 94.09 | 27965 | >6000 |
| 10-AA1 Diutan | 95.43 | 248 | >6000 |
| 10-V1 Methyl | 81.62 | 2376 | >6000 |
| cellulose | | | |
| 10-AC1 Gellan gum | 16.63 | 4412 | >6000 |
| 10-H1 HPC | 96.54 | 1063 | >6000 |

### Example 12

This example provides information related to suitable silica materials identified in accordance with the present invention.

| Formulation | CSP Grade | Description | Density, g/ml | SiO2, % wt |
|---|---|---|---|---|
| Ludox by Grace | TM50 | monomodal | 1.388-1.407 | 49.0-51.0 |
| | AM | 30% suspension with | 1.199-1.216 | 29.0-31.0 |
| | | aluminum oxide | | |
| | | (Al2O3) | | |
| | HSA | 30% suspension, | 1.199-1.216 | 29.0-31.0 |
| | | acidic | | |
| | TMA | 34% suspension, | 1.227-1.244 | 33.0-35.0 |
| | | acidic | | |
| Levasil by Nouryon | CS30-425 | aluminate modified | 1.200 | 30.0 |
| | CS40-614P | ammonia stabilized | 1.300 | 40.0 |
| | CS50-120 | sodium stabilized | 1.400 | 50.0 |
| | CS34-720 | non-charger | 1.200 | 34.0 |
| | | particles/deionized | | |
| | CS40-213 | sodium stabilized | 1.300 | 40.0 |
| | CS50-28 | sodium stabilized | 1.400 | 50.0 |
| | SP3088D | non-charger | 1.200 | 35.0 |
| | | particles/deionized | | |
| | CC401 | silane modified | 1.260 | 37.0 |
| | CS30-516P | Cationically stabilized | 1.205 | 31.09 |
| | | acidic silica | | |

| | Surface Area, | Surface | pH of silica | Additional |
|---|---|---|---|---|
| Formulation | m2/g | Charge | suspension | information |
| Ludox by | 110-150 | Negative | 8.5-9.5 | Sodium Counterion |
| Grace | 198-258 | | 8.6-9.3 | Al2O3: 0.17-0.21 wt % |
| | 198-258 | | 3.5-5.0 | |
| | 110-150 | | <=7.0 | Na2SO4: <=0.11 wt % |
| Levasil by | 250 | Negative | 6.5 | Al2O3: 0.25 wt % |
| Nouryon | 140 | Negative | 9.4 | NH3: 0.17 wt % |
| | 190 | Negative | 10 | Na2O: 0.45 wt % |
| | 200 | Close to Neutral | 2.8 | Na: ~200 ppm |
| | 130 | Negative | 9.1 | Na2O: 0.20 wt % |
| | 80 | Negative | 9.5 | Na2O: 0.20 wt % |
| | 85 | Close to Neutral | 2.8 | Na2O: 0.04 wt % |
| | 220 | Slight to Neutral | 8 | n/a |
| | 157 | Positive | 3.9 | n/a |

### Example 13

Following are described fire retardant concentrates prepared in accordance with the present invention and diluted solutions prepared therefrom. The drip test data are reported as averages of three tests. As shown, each of the tested compositions provided films that did not break when subjected to, on average, greater than 6000 milliliters (mL) of water.

| | Formulation | | | | | |
|---|---|---|---|---|---|---|
| | 13- T] | | 13-B | | 13-E | |
| | Thickener | | | | | |
| | Xanthan | | Casein sodium salt | | Polyethylene glycol | |
| Raw Materials | % Conc. | % Dilute | % Conc. | % Dilute | % Conc. | % Dilute |
| MAP | 22.26 | 4.65 | 22.26 | 4.68 | 22.26 | 4.66 |
| DAP | 25.11 | 5.25 | 25.11 | 5.28 | 25.11 | 5.26 |
| Water | 39.97 | 87.46 | 39.97 | 87.38 | 39.97 | 87.43 |
| Thickener | 1.20 | 0.25 | 1.20 | 0.25 | 1.20 | 0.25 |
| Clay | 2.00 | 0.42 | 2.00 | 0.42 | 2.00 | 0.42 |
| Tolyltriazole | 0.16 | 0.03 | 0.16 | 0.03 | 0.16 | 0.03 |
| Sodium molybdate | 0.10 | 0.02 | 0.10 | 0.02 | 0.10 | 0.02 |
| (NaMo) | | | | | | |
| Colloidal Silica | — | | | | | |
| (Negative charge) | 9.20 | 1.92 | 9.20 | 1.93 | 9.20 | 1.93 |
| (Neutral charge) | — | — | — | — | — | — |
| (Positive charge) | — | — | — | — | — | — |
| Total | 100.00 | 100.00 | 100.00 | 100.00 | 100.00 | 100.00 |
| Viscosity (cP) spin#2 | — | | | | | |
| Initial | 85 | 134 | 59 | 12 | 56 | 21 |
| 24 hr | 49 | 150 | 51 | 8 | 42 | 13 |
| s.g. | 1.347 | 1.062 | 1.358 | 1.070 | 1.351 | 1.067 |
| R.I (Brix), (10440) | 49.5 | 10.5 | 49.2 | 10.8 | 49.3 | 10.6 |
| pH | 6.14 | 6.45 | 5.92 | 6.26 | 6.03 | 6.44 |

| | | | |
|---|---|---|---|
| Drip Test (mL used) (avg) | >6000 | >6000 | >6000 |

| | Formulation | | | | | |
|---|---|---|---|---|---|---|
| | 13-F | | 13-G | | 13-H | |
| | Thickener | | | | | |
| | Castor oil | | Guar gum | | Casein sodium salt | |
| Raw Materials | % Conc. | % Dilute | % Conc. | % Dilute | % Conc. | % Dilute |
| MAP | 22.26 | 4.60 | 22.26 | 4.66 | 22.26 | 4.49 |
| DAP | 25.11 | 5.19 | 25.11 | 5.25 | 25.11 | 5.06 |
| Water | 39.97 | 87.60 | 39.97 | 87.44 | 39.97 | 87.90 |
| Thickener | 1.20 | 0.25 | 1.20 | 0.25 | 1.20 | 0.24 |
| Clay | 2.00 | 0.41 | 2.00 | 0.42 | 2.00 | 0.40 |
| Tolyltriazole | 0.16 | 0.03 | 0.16 | 0.03 | 0.16 | 0.03 |
| NaMo | 0.10 | 0.02 | 0.10 | 0.02 | 0.10 | 0.02 |
| Colloidal Silica | | | | | | |
| (Negative charge) | 9.20 | 1.90 | 9.20 | 1.92 | — | — |
| (Neutral charge) | — | — | — | — | 9.20 | 1.85 |
| (Positive charge) | — | — | — | — | — | — |
| Total | 100.00 | 100.00 | 100.00 | 100.00 | 100.00 | 100.00 |
| Viscosity (cP) spin#2 | | | | | | |
| Initial | 69 | 16 | 89 | 34 | 180 | 14 |
| 24 hr | 71 | 11 | 53 | 35 | 175 | 14 |
| s.g. | 1.328 | 1.063 | 1.349 | 1.067 | 1.288 | 1.064 |
| R.I (Brix), (10440) | 49.3 | 10.3 | 49.5 | 10.8 | 48.4 | 10.7 |
| pH | 6.07 | 6.42 | 5.85 | 6.26 | 5.93 | 6.24 |

| | | | |
|---|---|---|---|
| Drip Test (mL used) (avg) | >6000 | >6000 | >6000 |

| | Formulation | | | | | |
|---|---|---|---|---|---|---|
| | 13-I | | 13-K | | 13-J | |
| | Thickener | | | | | |
| | Polyethylene glycol | | Castor oil | | Guar gum | |
| Raw Materials | % Conc. | % Dilute | % Conc. | % Dilute | % Conc. | % Dilute |
| MAP | 22.26 | 4.39 | 22.26 | 4.54 | 22.26 | 4.54 |
| DAP | 25.11 | 4.95 | 25.11 | 5.12 | 25.11 | 5.12 |
| Water | 39.97 | 88.17 | 39.97 | 87.75 | 39.97 | 87.76 |
| Thickener | 1.20 | 0.24 | 1.20 | 0.24 | 1.20 | 0.24 |
| Clay (attapulgite) | 2.00 | 0.39 | 2.00 | 0.41 | 2.00 | 0.41 |
| Tolyltriazole | 0.16 | 0.03 | 0.16 | 0.03 | 0.16 | 0.03 |
| NaMo | 0.10 | 0.02 | 0.10 | 0.02 | 0.10 | 0.02 |
| Colloidal Silica | | | | | | |
| (Negative charge) | — | — | — | — | — | — |
| (Neutral charge) | 9.20 | 1.81 | 9.20 | 1.88 | 9.20 | 1.88 |
| (Positive charge) | — | — | — | — | — | — |
| Total | 100.00 | 100.00 | 100.00 | 100.00 | 100.00 | 100.00 |
| Viscosity (cP) spin#2 | | | | | | |
| Initial | 204 | 12 | 183 | 21 | 191 | 30 |
| 24 hr | 193 | 11 | 187 | 11 | 188 | 35 |
| s.g. | 1.252 | 1.062 | 1.307 | 1.062 | 1.306 | 1.065 |
| R.I (Brix), (10440) | 48.2 | 10.4 | 48.6 | 10.2 | 48.5 | 10.7 |
| pH | 5.89 | 6.24 | 5.92 | 6.30 | 5.87 | 6.17 |

| | | | |
|---|---|---|---|
| Drip Test (mL used) (avg) | >6000 | >6000 | >6000 |

| | Formulation | | | | | | | |
|---|---|---|---|---|---|---|---|---|
| | 13-P | | 13-Q | | 13-R | | 13-S | |
| | Thickener | | | | | | | |
| | Casein sodium | | Polyethylene | | | | | |
| | salt | | glycol | | Castor oil | | Guar gum | |
| Raw Materials | % Conc. | % Dilute | % Conc. | % Dilute | % Conc. | % Dilute | % Conc. | % Dilute |
| MAP | 22.26 | 4.60 | 22.26 | 4.61 | 22.26 | 4.60 | 22.26 | 4.60 |
| DAP | 25.11 | 5.19 | 25.11 | 5.20 | 25.11 | 5.18 | 25.11 | 5.19 |
| Water | 39.97 | 87.59 | 39.97 | 87.58 | 39.97 | 87.61 | 39.97 | 87.58 |
| Thickener | 1.20 | 0.25 | 1.20 | 0.25 | 1.20 | 0.25 | 1.20 | 0.25 |
| Clay | 2.00 | 0.41 | 2.00 | 0.41 | 2.00 | 0.41 | 2.00 | 0.41 |
| Tolyltriazole | 0.16 | 0.03 | 0.16 | 0.03 | 0.16 | 0.03 | 0.16 | 0.03 |
| NaMo | 0.10 | 0.02 | 0.10 | 0.02 | 0.10 | 0.02 | 0.10 | 0.02 |
| Colloidal Silica | | | | | | | | |
| (Negative charge) | — | — | — | — | — | — | — | — |
| (Neutral charge) | — | — | — | — | — | — | — | — |
| (Positive charge) | 9.20 | 1.90 | 9.20 | 1.90 | 9.20 | 1.90 | 9.20 | 1.90 |
| Total | 100.00 | 100.00 | 100.00 | 100.00 | 100.00 | 100.00 | 100.00 | 100.00 |
| Viscosity (cP) spin#2 | | | | | | | | |
| Initial | 63 | 19 | 54 | 8 | 53 | 8 | 54 | 28 |
| 24 hr | 61 | 15 | 53 | 11 | 36 | 13 | 49 | 35 |
| s.g. | 1.329 | 1.064 | 1.331 | 1.064 | 1.327 | 1.062 | 1.330 | 1.065 |
| R.I (Brix), (10440) | 48.4 | 10.3 | 48.5 | 10.7 | 48.3 | 10.4 | 48.2 | 10.7 |
| pH | 5.81 | 6.23 | 5.87 | 6.24 | 5.90 | 6.31 | 5.85 | 6.25 |
| Drip Test (mL used) | >6000 | | >6000 | | >6000 | | >6000 | |
| (avg) | | | | | | | | |

### Example 14

The following example details formulations and drip testing results for formulations prepared to contain 0.05 wt % thickener when diluted. As shown, each formulation did not break when subjected to greater than 6000 mL of water, on average.

| | Formulation | | | | | | | |
|---|---|---|---|---|---|---|---|---|
| | 14-L | | 14-M | | 14-N | | 14-O | |
| | Thickener | | | | | | | |
| | Casein sodium | | Polyethylene | | | | | |
| | salt | | glycol | | Castor oil | | Guar gum | |
| Raw Materials | % Conc. | % Dilute | % Conc. | % Dilute | % Conc. | % Dilute | % Conc. | % Dilute |
| MAP | 22.72 | 4.74 | 22.72 | 4.76 | 22.72 | 4.72 | 22.72 | 4.82 |
| DAP | 25.61 | 5.34 | 25.61 | 5.36 | 25.61 | 5.32 | 25.61 | 5.44 |
| Water | 39.97 | 87.49 | 39.97 | 87.44 | 39.97 | 87.52 | 39.97 | 87.25 |
| Thickener | 0.24 | 0.05 | 0.24 | 0.05 | 0.24 | 0.05 | 0.24 | 0.05 |
| Clay | 2.00 | 0.42 | 2.00 | 0.42 | 2.00 | 0.42 | 2.00 | 0.42 |
| Tolyltriazole | 0.16 | 0.03 | 0.16 | 0.03 | 0.16 | 0.03 | 0.16 | 0.03 |
| NaMo | 0.10 | 0.02 | 0.10 | 0.02 | 0.10 | 0.02 | 0.10 | 0.02 |
| Colloidal Silica | 9.20 | 1.92 | 9.20 | 1.93 | 9.20 | 1.91 | 9.20 | 1.95 |
| Total | 100.00 | 100.00 | 100.00 | 100.00 | 100.00 | 100.00 | 100.00 | 100.00 |
| Viscosity (cP) spin#2 | | | | | | | | |
| Initial | 94 | 23 | 68 | 13 | 69 | 22 | 72 | 12 |
| 24 hr | 58 | 13 | 48 | 13 | 44 | 13 | 45 | 11 |
| s.g. | 1.343 | 1.068 | 1.350 | 1.068 | 1.338 | 1.068 | 1.375 | 1.069 |
| R.I (Brix), (10440) | 49.5 | 10.9 | 49.4 | 10.7 | 49.7 | 10.9 | 49.6 | 10.8 |
| pH | 5.94 | 6.30 | 5.98 | 6.30 | 5.92 | 6.29 | 5.94 | 6.31 |
| Drip Test (mL used) | >6000 | | >6000 | | >6000 | | >6000 | |
| (avg) | | | | | | | | |

### EMBODIMENTS

For further illustration, additional non-liming embodiments of the present invention are set forth below.

Embodiment A is a liquid fire retardant concentrate composition, the composition comprising: one or more fire retardants; xanthan gum; and colloidal silica particles, wherein the weight ratio of xanthan gum to colloidal silica particles present in the composition is between 1:5 and 1:10.

Embodiment A1 is the composition of Embodiment A wherein the composition comprises xanthan gum cross-linked by colloidal silica particles.

Embodiment A2 is the composition of Embodiment A or A1 wherein the composition comprises a hydrogel that forms a coating over at least a portion of the one or more fire retardants.

Embodiment A3 is the composition of any of Embodiments A to A2 wherein xanthan gum is present in a proportion of at least about 0.5 wt %, at least about 1 wt %, or at least about 1.5 wt % of the composition.

Embodiment A4 is the composition of any of Embodiments A to A3 wherein xanthan gum is present in a proportion of from about 0.5 wt % to about 2 wt %, from about 1 wt % to about 1.5 wt %, or from about 1.1 wt % to about 1.3 wt % of the composition.

Embodiment A5 is the composition of any of Embodiments A to A4 wherein colloidal silica particles are present in a proportion of from about 5 wt % to about 10 wt % of the composition.

Embodiment A6 is the composition of any of Embodiments A to A5 wherein the weight ratio of xanthan gum to colloidal silica particles is from about 1:6 to about 1:9, or from about 1:7 to about 1:8.

Embodiment A7 is the composition of any of Embodiments A to A6 wherein the colloidal silica particles have a BET surface area of from about 125 m²/g to about 300 m²/g, or from about 130 m²/g to about 260 m²/g and/or a particle size of from about 30 to about 500 nanometers (nm) in diameter.

Embodiment A8 is the composition of any of Embodiments A to A7 further comprising micronized clay, the micronized clay present in a proportion of from about 1 wt % to about 3 wt %, or from about 1.5 wt % to about 2.5 wt %.

Embodiment A9 is the composition of Embodiments A8 wherein the micronized clay is selected from the group consisting of attapulgite clay, kaolinite clay, halloysite clay, bentonite clay, sepiolite, and combinations thereof.

Embodiment A10 is the composition of any of Embodiments A to A9 wherein the weight ratio of xanthan gum to micronized clay is from about 1:3 to about 1:0.6.

Embodiment A11 is the composition of any of Embodiments A to A10 wherein the weight ratio of micronized clay to colloidal silica particles is from about 1:3 to about 1:4.

Embodiment A12 is the composition of any of Embodiments A to A11 wherein the one or more fire retardants are selected from the group consisting of monoammonium phosphate (MAP), diammonium phosphate (DAP), ammonium polyphosphate (APP), magnesium chloride, and combinations thereof.

Embodiment A13 is the composition of any of Embodiments A to A12 wherein the composition further comprises a corrosion inhibitor, wherein the corrosion inhibitor constitutes at least about 0.01 wt %, from about 0.01 wt % to about 1 wt %, or from about 0.01 wt % to about 0.5 wt %.

Embodiment A14 is the composition of any of Embodiments A to A13 wherein the composition further comprises a molybdate corrosion inhibitor comprising sodium molybdate, potassium molybdate, lithium molybdate, or any combination thereof.

Embodiment A15 is the composition of Embodiment A14 wherein the molybdate corrosion inhibitor comprises sodium molybdate.

Embodiment A16 is the composition of any of Embodiments A to A15 to wherein the composition further comprises an azole corrosion inhibitor selected from the group consisting of benzotriazole, tolytriazole, and combinations thereof.

Embodiment A17 is the composition of Embodiment A16 wherein the azole corrosion inhibitor comprises tolytriazole.

Embodiment A18 is the composition of any of Embodiments A to A17 wherein the composition exhibits a viscosity of from about 100 cP to about 1000 cP.

Embodiment A19 is the composition of any of Embodiments A to A18 wherein the composition exhibits a viscosity after 24 hours of storage of from 10 cP to about 400 cP.

Embodiment A20 is the composition of any of Embodiments A to A19 wherein the composition exhibits a specific gravity of from about 1.0 to about 1.4.

Embodiment A21 is the composition of any of Embodiments A to A20 wherein the composition exhibits a pH of from about 5.5 to about 6.5.

Embodiment B is a solid fire retardant concentrate composition, the composition comprising one or more fire retardants, xanthan gum, particulate silica, and micronized clay.

Embodiment B1 is the composition of Embodiment B, wherein the one or more fire retardants are selected from the group consisting of monoammonium phosphate (MAP), diammonium phosphate (DAP), ammonium polyphosphate (APP), magnesium chloride, and combinations thereof.

Embodiment B2 is the composition of Embodiment B1, wherein the one or more fire retardants constitute at least about 1 wt %, from about 1 wt % to about 60 wt %, from about 10 wt % to about 50 wt %, from about 10 wt % to about 40 wt %, from about 10 wt % to about 30 wt %, or about 20 wt % of the composition.

Embodiment B3 is the composition of any of Embodiments B to B2, wherein xanthan gum constitutes at least about 0.5 wt %, or from about 0.5 wt % to about 7.5 wt % of the composition.

Embodiment B4 is the composition of any of Embodiments B to B3, wherein particulate silica constitutes at least about 0.5 wt %, or from about 0.5 wt % to about 10 wt % of the composition.

Embodiment B5 is the composition of any of Embodiments B to B4, wherein micronized clay constitutes at least about 0.5 wt %, or from about 0.5 wt % to about 5 wt % of the composition.

Embodiment B6 is the composition of any of Embodiments B to B5, the concentrate further comprising a flow conditioner.

Embodiment B7 is the composition of Embodiment B6, wherein the flow conditioner is present in a proportion of at least about 0.1 wt %, at least about 0.25 wt %, at least about 0.5 wt %, at least about 0.75 wt %, at least about 1 wt %, at least about 1.25 wt %, at least about 1.5 wt %, at least about 2 wt %, at least about 3 wt %, or even at least about 4 wt %. In various embodiments, the flow conditioner is present in a proportion of from about 0.25 wt % to about 5 wt %, from about 0.25 wt % to about 4 wt %, from about 0.25 wt % to about 3 wt %, from about 0.5 wt % to about 2 wt %, from about 0.5 wt % to about 1.75 wt %, from about 0.75 wt % to about 1.5 wt %, or from about 1 wt % to about 1.5 wt.

Embodiment B8 is the composition of Embodiment B6 or B7, wherein the flow conditioner is selected from the group consisting of tricalcium phosphate, silicon dioxide (e.g., micronized silica), sodium alumino silicate, calcium silicate, aluminum silicate, cellulose, magnesium oxide, and mixtures thereof.

Embodiment B9 is the composition of any of Embodiments B6, B7, or B8 wherein the flow conditioner and magnesium chloride are present at a weight ratio of from about 1:50 to about 1:75.

Embodiment B10 is the composition of any of Embodiments B to B9 further comprising one or more thickeners selected from the group consisting of xanthan gum, rhamsan gum, welan gum, diutan gum, guar gum, and mixtures thereof.

Embodiment B11 is the composition of Embodiment B10, wherein the thickener is present in a proportion of at least about 1 wt %, at least about 1.5 wt %, at least about 2 wt %, or at least about 2.5 wt %, from about 1 wt % to about 3 wt %, from about 1.5 wt % to about 3 wt %, from about 2 wt % to about 3 wt %, or from about 2.25 wt % to about 2.75 wt %, or about 2.5 wt %.

Embodiment B12 is the composition of any of Embodiments B to B11 further comprising a corrosion inhibitor.

Embodiment B13 is the composition of Embodiment B12 comprising an azole corrosion inhibitor selected from tolytriazole and/or benzotriazole.

Embodiment B14 is the composition of Embodiment B13, wherein the azole corrosion inhibitor is present in a proportion of from about 0.01% to about 2.0% by weight of the total concentrate concentration, from about 0.05% to about 0.3% by weight of the total concentrate concentration, or the amount of the azole corrosion inhibitor of is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

Embodiment B15 is the composition of any of Embodiments B12 to B14, the concentrate comprising a molybdate corrosion inhibitor selected from anhydrous sodium molybdate, its dihydrate, or mixtures thereof.

Embodiment B16 is the composition of Embodiment B15, wherein the molybdate corrosion inhibitor is present in a proportion of from about 0.01% to about 2.0% by weight of the total concentrate concentration, from about 0.05% to about 0.3% by weight of the total concentrate concentration, or the amount of anhydrous sodium molybdate, its dihydrate, and mixtures thereof is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

Embodiment B17 is the composition of any of Embodiments B to B16, the composition further comprising a stability enhancer.

Embodiment B18 is the composition of Embodiment B17, wherein the stability enhancer comprises dimercaptothiadiazole (DMTD).

Embodiment B19 is the composition of Embodiment B17 or B18 wherein the stability enhancer component is present in a proportion of at least about 0.1 wt %, at least about 0.2 wt %, at least about 0.3 wt %, at least about 0.4 wt %, at least about 0.5 wt %, or from about 0.1 wt % to about 1 wt %.

Embodiment B20 is the composition of any of Embodiments B to B19, wherein the concentrate composition is uncolored.

Embodiment B21 is the composition of any of Embodiments B to B20, wherein the composition comprises a pigment or a dye, wherein the pigment or dye comprises red iron oxide, brown iron oxide, titanium dioxide or a fugitive pigment or dye.

Embodiment B22 is the composition of any of Embodiments B to B21, wherein the composition comprises a fugitive pigment and a water insoluble opaque material.

Embodiment B23 is the composition of any of Embodiments B to B22, wherein the composition comprises an additional component selected from a surfactant, a foam controlling additive, a biocide, and any combination thereof in a proportion of at least about 0.05 wt %, at least about 0.1 wt %, from about 0.05 wt % to about 1 wt %, or from about 0.1 wt % to about 0.5 wt %.

Embodiment B24 is the composition of any of claims Embodiments B to B23, wherein the concentrate is in the form of a dry powder.

Embodiment B25 is the composition of any of Embodiments B to B24, wherein the concentrate is in the form of a flowable powder.

Embodiment B26 is a fire retardant solution comprising the fire retardant concentrate of any of Embodiments A to B25 and water.

Embodiment C is directed to a hydrogel, wherein the hydrogel comprises water, xanthan gum, and colloidal silica, and: xanthan gum is present in a proportion of from about 0.05 wt % to about 5 wt %, and colloidal silica is present in a proportion of between 1 wt % and 5 wt %.

Embodiment D is directed to a hydrogel, wherein the hydrogel comprises water, xanthan gum, and colloidal silica, and: xanthan gum is present in a proportion of from about 0.05 wt % to about 5 wt %, colloidal silica is present in a proportion of from about 1 wt % to about 5 wt %, and the xanthan gum and colloidal silica are present in a weight ratio of xanthan gum to colloidal silica of between 1:5 and 1:10.

Embodiment D1 is hydrogel of Embodiment C or D, wherein xanthan gum is present in a proportion of at least about 0.05 wt %, at least about 0.1 wt %, at least about 0.15 wt %, at least about 0.2 wt %, from about 0.1 wt % to about 4 wt %, from about 0.2 wt % to about 2 wt %, or from about 0.2 wt % to about 1 wt %.

Embodiment D2 is the hydrogel of any of Embodiments C to D1, wherein colloidal silica is present in a proportion of at least about 0.1 wt %, at least about 0.2 wt %, at least about 0.5 wt %, at least about 1 wt %, at least about 1.5 wt %, from about 0.1 wt % to about 5 wt %, from about 0.1 wt % to about 3 wt %, or from about 0.1 wt % to about 2 wt %.

Embodiment D3 is the hydrogel of any of Embodiments C to D2, wherein the colloidal silica has a surface area of from about 125 m²/g to about 300 m²/g, or from about 130 m²/g to about 260 m²/g.

Embodiment D4 is the hydrogel of any of Embodiments C to D3, wherein xanthan gum and colloidal silica are present in a weight ratio of from about 1:0.1 to about 1:0.5, from about 1:1 to about 1:20, or between 1:5 and 1:10.

Embodiment D5 is the hydrogel of any of Embodiments C to D4, wherein the initial viscosity is at least about 100 centipoise (cP), at least about 150 cP, at least about 200 cP, at least about 300 cP, at least about 400 cP, at least about 500 cP, at least about 600 cP, at least about 700 cP, at least about 800 cP, or at least about 1000 cP.

Embodiment D6 is the hydrogel of any of Embodiments C to D5, wherein the viscosity after storage for 24 hours is at least about 100 cP, at least about 150 cP, at least about 200 cP, at least about 300 cP, at least about 400 cP, at least about 500 cP, at least about 600 cP, at least about 700 cP, at least about 800 cP, or at least about 1000 cP.

Embodiment D7 is the hydrogel of any of Embodiments C to D6, wherein the specific gravity is at least about 0.8, at least about 0.9, at least about 1.0, from about 0.8 to about 1.2, from about 0.9 to about 1.1, or from about 0.95 to about 1.05.

Embodiment E is a hydrogel, wherein the hydrogel comprises water, micronized clay, and colloidal silica, and water is present in a proportion of at least about 90 wt %, micronized clay is present in a proportion of from about 0.5 wt % to about 7 wt %, and colloidal silica is present in a proportion of from about 0.1 wt % to about 5 wt %.

Embodiment E1 the hydrogel of Embodiment E, wherein the micronized clay is selected from the group consisting of attapulgite clay, kaolinite clay, halloysite clay, bentonite clay, sepiolite, and combinations thereof.

Embodiment E2 is the hydrogel of Embodiment E or E1, wherein the micronized clay is present in a proportion of at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt, about least about 2 wt %, at least about 2.1 wt %, at least about 2.2 wt %, at least about 2.3 wt %, at least about 2.4 wt, or at least about 2.5 wt %.

Embodiment E3 is the hydrogel of Embodiment E2, wherein the micronized clay is present in a proportion of less than about 6.5 wt %, less than about 6 wt %, less than about 6.5 wt %, less than about 6 wt %, less than about 5.5 wt %, less than about 5 wt %, less than about 4.9 wt %, less than about 4.8 wt %, less than about 4.7 wt %, less than about 4.6 wt %, less than about 4.5 wt %, less than about 4.4 wt %, less than about 4.3 wt %, less than about 4.2 wt %, less than about 4.1 wt %, less than about 4 wt %, less than about 3.9 wt %, less than about 3.8 wt %, less than about 3.7 wt %, less than about 3.6 wt %, less than about 3.5 wt %, less than about 3.4 wt %, less than about 3.3 wt %, less than about 3.2 wt %, less than about 3.1 wt %, less than about 3 wt %, less than about 2.9 wt %, less than about 2.8 wt %, less than about 2.7 wt %, less than about 2.6 wt %, or less than about 2.5 wt %.

Embodiment E4 is the hydrogel of Embodiment E2 or E3, wherein micronized clay is present in a proportion of from about 1 wt % to about 3 wt %, or from about 1.5 wt % to about 2.5 wt %.

Embodiment E5 is the hydrogel of any of Embodiments E to E4, wherein colloidal silica is present in a proportion of at least about 0.2 wt %, at least about 0.5 wt %, at least about 1 wt %, at least about 1.5 wt %, from about 0.1 wt % to about 3 wt %, or from about 0.1 wt % to about 2 wt % of the composition.

Embodiment E6 is the hydrogel of any of Embodiments E to E5, wherein the colloidal silica has a surface area of from about 125 m²/g to about 300 m²/g, or from about 130 m²/g to about 260 m²/g.

Embodiment E7 is the hydrogel of any of Embodiments E to E6, wherein micronized clay and colloidal silica are present in a proportion of from about 1:0.1 to about 1:0.5, from about 1:1 to about 1:20, or between 1:5 and 1:10.

Embodiment E8 is the hydrogel of any of Embodiments E to E7, wherein the viscosity is at least about 5 centipoise (cP), at least about 10 cP, at least about 15 cP, at least about 20 cP, at least about 25 cP, at least about 30 cP, at least about 40 cP, at least about 45 cP, at least about 60 cP, or at least about 70 cP.

Embodiment E9 is the hydrogel of any of Embodiments E to E8, wherein the viscosity after 24 hours of storage is at least about 5 centipoise (cP), at least about 10 cP, at least about 15 cP, at least about 20 cP, at least about 25 cP, at least about 30 cP, at least about 40 cP, at least about 45 cP, at least about 60 cP, or at least about 70 cP.

Embodiment E10 is the hydrogel of any of Embodiments E to E9, wherein the specific gravity is at least about 0.8, at least about 0.9, at least about 1.0, from about 0.8 to about 1.2, from about 0.9 to about 1.1, or from about 0.95 to about 1.05.

Embodiment E11 is the hydrogel of any of Embodiments C to E10, wherein the hydrogel consists essentially of: (i) water, (ii) xanthan gum or micronized clay, (iii) colloidal silica, and (iv) one or more active agents.

Embodiment E12 is the hydrogel of any of Embodiments C to E11, wherein the hydrogel consists of: (i) water, (ii) xanthan gum or micronized clay, (iii) colloidal silica, and (iv) one or more active agents.

Embodiment E13 is the hydrogel of any of Embodiments C to E12, wherein the one or more active agents are selected from the group consisting of pharmaceutically active compounds, fire retardants, flame retardants, herbicides, pesticides, insecticides, fertilizers, pigments, and dyes.

Embodiment E14 is the hydrogel of any of Embodiments C to E13, wherein the hydrogel is utilized in a medical application selected from tissue engineering and contact lenses.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description shall be interpreted as illustrative and not in a limiting sense.

1. A liquid fire retardant concentrate composition, the composition comprising:
one or more fire retardants;
a biopolymer;
colloidal silica particles; and/or
micronized clay.

2. The composition of claim 1 wherein the biopolymer is selected from the group consisting of xanthan gum, guar gum, dextran, welan gum, gellan gum, diutan gum, pullulan, algin, collagen, casein, albumin, castor oil, cornstarch, arrowroot, yuca starch, carrageenan, konjac, alginate, gelatin, agar, pectin, cellulose gum, acacia guar gum, locust bean gum, acacia gum, gum tragacanth, glucomannan, alginic acid, sodium alginate, potassium alginate, ammonium alginate, calcium alginate, chitosan, carboxymethyl cellulose (CMC), methyl cellulose (MEC), hydroxyethyl cellulose (HEC), hydroxymethyl cellulose (HMC), hydroxypropyl methylcellulose (HPMC), ethylhydroxyethyl cellulose, and combinations thereof.

3. The composition of claim 2 wherein the biopolymer is xanthan gum.

4. The composition of claim 1 wherein the biopolymer is selected from the group consisting of polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof.

5. The composition of claim 4 wherein the biopolymer is selected from diutan gum, welan gum, and hydroxyethyl cellulose.

6. The composition of any of the preceding claims wherein the biopolymer is present in a concentration of at least about 0.5 wt %, at least about 0.6 wt %, at least about 0.7 wt %, at least about 0.8 wt %, at least about 0.9 wt %, at least about 1 wt %, at least about 1.1 wt %, or at least about 1.2 wt %.

7. The composition of any of the preceding claims wherein the biopolymer is present in a concentration of from about 0.5 wt % to about 1.5 wt %, from about 0.6 wt % to about 1.4 wt %, or from about 0.8 wt % to about 1.2 wt %.

8. The composition of any of the preceding claims wherein the composition comprises the biopolymer cross-linked by colloidal silica particles.

9. The composition of any of the preceding claims wherein the composition comprises a hydrogel that forms a coating over at least a portion of the one or more fire retardants.

10. The composition of any of the preceding claims wherein the composition is a water-resistant film-forming composition.

11. The composition of any of the preceding claims wherein the colloidal silica particles are present in a proportion of at least about 5 wt %, at least about 6 wt %, at least about 7 wt %, or at least about 8 wt %.

12. The composition of any of the preceding claims wherein colloidal silica particles are present in a proportion of from about 6 wt % to about 12 wt %, from about 5 wt % to about 10 wt %, or from about 8 wt % to about 10 wt % of the composition.

13. The composition of any of the preceding claims wherein the colloidal silica particles are negatively charged, neutral, or positively charged.

14. The composition of any of the preceding claims wherein the weight ratio of biopolymer to colloidal silica particles is from about 1:6 to about 1:9, or from about 1:7 to about 1:8.

15. The composition of any of the preceding claims wherein the colloidal silica particles have a BET surface area of from about 125 m²/g to about 300 m²/g, or from about 130 m²/g to about 260 m²/g and/or a particle size of from about 30 to about 500 nanometers (nm) in diameter.

16. The composition of any of the preceding claims wherein the micronized clay present in a proportion of from about 1 wt % to about 3 wt %, or from about 1.5 wt % to about 2.5 wt %.

17. The composition of any of the preceding claims wherein the micronized clay is selected from the group consisting of attapulgite clay, kaolinite clay, halloysite clay, bentonite clay, sepiolite, and combinations thereof.

18. The composition of any of the preceding claims wherein the weight ratio of biopolymer to micronized clay is from about 1:3 to about 1:0.6.

19. The composition of any of the preceding claims wherein the weight ratio of micronized clay to colloidal silica particles is from about 1:3 to about 1:4.

20. The composition of any of the preceding claims wherein the composition comprises colloidal silica particles and micronized clay.

21. The composition of any of the preceding claims wherein the one or more fire retardants are selected from the group consisting of monoammonium phosphate (MAP), diammonium phosphate (DAP), ammonium polyphosphate (APP), magnesium chloride, and combinations thereof.

22. The composition of claim 21 wherein the one or more fire retardants comprises MAP and DAP.

23. The composition of claim 22 wherein MAP and/or DAP are present in a concentration at least about 10 wt %, at least about 15 wt %, or at least about 20 wt %.

24. The composition of claim 22 wherein MAP and/or DAP are present in a concentration of from about 10 wt % to about 40 wt %, from about 15 wt % to about 35 wt %, or from about 20 wt % to about 25 wt %.

25. The composition of any of the preceding claims wherein the composition further comprises a corrosion inhibitor, wherein the corrosion inhibitor constitutes at least about 0.01 wt %, from about 0.01 wt % to about 1 wt %, or from about 0.01 wt % to about 0.5 wt %.

26. The composition of any of the preceding claims wherein the composition further comprises a molybdate corrosion inhibitor comprising sodium molybdate, potassium molybdate, lithium molybdate, or any combination thereof.

27. The composition of claim 26 wherein the molybdate corrosion inhibitor comprises sodium molybdate.

28. The composition of any of the preceding claims wherein the composition further comprises an azole corrosion inhibitor selected from the group consisting of benzotriazole, tolytriazole, and combinations thereof.

29. The composition of claim 28 wherein the azole corrosion inhibitor comprises tolytriazole.

30. The composition of any of the preceding claims wherein the composition comprises at least about 25 wt %, at least about 30 wt %, at least about 35 wt %, or at least about 40 wt % water.

31. The composition of any of the preceding claims wherein the composition comprises from about 25 wt % to about 50 wt % or from about 35 wt % to about 45 wt % water.

32. The composition of any of the preceding claims wherein the composition exhibits a viscosity of from about 50 cP to about 1000 cP.

33. The composition of any of the preceding claims wherein the composition exhibits a viscosity after 24 hours of storage of from 10 cP to about 400 cP.

34. The composition of any of the preceding claims wherein the composition exhibits a specific gravity of from about 1.0 to about 1.4.

35. The composition of any of the preceding claims wherein the composition exhibits a pH of from about 5.5 to about 6.5.

36. A liquid fire retardant concentrate composition, the composition comprising:
one or more fire retardants, the one or more fire retardants comprising monoammonium phosphate (MAP) and diammonium phosphate (DAP);
a biopolymer, wherein the biopolymer is selected from the group consisting of polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof;
colloidal silica particles;
micronized clay, wherein the micronized clay is selected from the group consisting of attapulgite clay, kaolinite clay, halloysite clay, bentonite clay, sepiolite, and combinations thereof; and wherein:
the MAP and DAP are each present in a concentration of from about 10 wt % to about 40 wt %;
the biopolymer is present in a concentration of from about 0.5 wt % to about 1.5 wt %;
the colloidal silica particles are present in a concentration of from about 6 wt % to about 12 wt %; and
the micronized clay is present in a concentration of from about 1 wt % to about 3 wt %.

37. A fire retardant solution comprising the fire retardant concentrate of any of the preceding claims and water.

38. The fire retardant solution of claim 37, wherein the solution is prepared by combining the fire retardant concentrate of any of claims 1 to 35 and water at a dilution of at least about 1.0 pound (lb.), at least about 1.5 lbs., or at least 2 lbs. of fire retardant concentrate per gallon of water.

39. The fire retardant solution of claim 37 or 38, wherein:
the fire retardant solution exhibits an aluminum corrosion rate equal to or less than 2.0 milli-inches or less than 1.0 milli-inches per year. In certain embodiments, a fire retardant solution exhibits a mild steel corrosion rate equal to or less than 5.0 milli-inches per year. In certain embodiments, a fire retardant solution exhibits a brass corrosion rate equal to or less than 5.0 milli-inches per year. In certain embodiments, a fire retardant solution exhibits two or more of the above described corrosion rates for magnesium, aluminum, mild steel and/or brass; and/or
the fire retardant solution meets one or more of the required criteria for of U.S. Department of Agriculture, Forest Service, Specification Number 5100-304d, January 2020, including any and all amendments; and/or
the fire retardant solution meets one or more of the required criteria for corrosion and/or stability of U.S. Department of Agriculture, Forest Service, Specification Number 5100-304d, January 2020, including all amendments; and/or
the fire retardant solution meets all of the required criteria for corrosion of U.S. Department of Agriculture, Forest Service, Specification Number 5100-304d, January 2020, including all amendments; and/or
the fire retardant solution meets all of the required criteria for stability of U.S. Department of Agriculture, Forest Service, Specification Number 5100-304d, January 2020, including all amendments; and/or
the fire retardant solution meets all of the required criteria for corrosion and stability of U.S. Department of Agriculture, Forest Service, Specification Number 5100-304d, January 2020, including all amendments; and/or
the fire retardant solution meets all of the required criteria of U.S. Department of Agriculture, Forest Service, Specification Number 5100-304d, January 2020, including all amendments; and/or
the fire retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments; and/or
the fire retardant solution exhibits an aquatic toxicity (LC50) in the range of from about 180 milligrams per liter to about 1500 milligrams per liter, an aquatic toxicity (LC50) greater than about 180, 200, 500, 1000, 2000, or 2500 milligrams per liter, or an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

40. A water-resistant film-forming composition, wherein the composition comprises water, a thickener, and colloidal silica, wherein:
the thickener is selected from the group consisting of polyethylene glycol, casein, albumin, gelatin, castor oil, chitosan, pullulan, dextran, xanthan gum, gellan gum, welan gum, diutan gum, arrowroot starch, corn starch, yuca starch, pectin, carboxymethyl cellulose, methyl cellulose, hydroxypropyl methyl cellulose, hydroxyethyl cellulose, konjac, guar gum, acacia gum, locust bean gum, tragacanth gum, agar agar, carrageenan, alginic acid, calcium alginate, sodium alginate, and combinations thereof;
the thickener is present in a concentration of from about 0.2 wt % to about 0.35 wt %;
colloidal silica is present in a concentration of from about 2 wt % to about 2.5 wt %;
the thickener and colloidal silica are present in a weight ratio (thickener:silica) of from about 0.01:1 to about 0.15:1; and
water constitutes at least about 95 wt % of the composition.

41. The composition of claim 40 wherein the thickener is present in a concentration of about 0.05 wt % or about 0.28 wt %.

42. The composition of claim 40 or 41 wherein the colloidal silica is present in a concentration of about 2.15 wt %.

43. The composition of any of claims 40 to 42 wherein the biopolymer and silica are present in a weight ratio (biopolymer:silica) of about 0.01:1, or about 0.13:1.

44. The composition of any of claims 40 to 43, wherein the composition further comprises micronized clay.

45. The composition of claim 44, wherein the micronized clay is selected from the group consisting of attapulgite clay, kaolinite clay, halloysite clay, bentonite clay, sepiolite, and combinations thereof.
